(19) United States
(12) Patent Application Publication
(10) Pub. No.: US 2025/0220047 A1
(43) Pub. Date: Jul. 3, 2025

(54) TRANSPORT LAYER TIME-ALIGNMENT CHARACTERIZATION FOR SCHEDULED TRAFFIC IN TIME SYNCHRONIZED NETWORKS

(71) Applicant: Intel Corporation, Santa Clara, CA (US)

(72) Inventors: Marcio Juliato, Portland, OR (US); Javier Perez-Ramirez, North Plains, OR (US); Manoj Sastry, Portland, OR (US); Christopher Gutierrez, Hillsboro, OR (US); Vuk Lesi, Cornelius, OR (US); Shabbir Ahmed, Portland, OR (US)

(21) Appl. No.: 18/400,117

(22) Filed: Dec. 29, 2023

(51) Int. Cl. H04L 9/40; H04L 41/0681

(52) U.S. Cl. CPC H04L 63/20; H04L 41/0681

(57) ABSTRACT

Techniques include a method, apparatus, system and computer-readable medium to detect, quantify and localize attacks to enhance security for time-synchronized networking. Embodiments include a diagnostic stream producer to produce diagnostic information providing evidence of a timing attack on a node of a time-synchronized network. Embodiments include a diagnostic stream consumer to consume diagnostic information, analyze the diagnostic information, and determine whether a node is under a timing attack. Other embodiments are described and claimed.

### BACKGROUND

Many computing systems (e.g., autonomous systems, industrial systems, etc.) require real-time safety features. This often necessitates that timekeeping performance within the system has higher levels of security relative to other aspects of the system. For example, factories employ synchronized robots to accomplish coordinated tasks, often in the presence of human beings. In another example, robots utilize coordination to perform surgeries on humans. As yet another example, self-driving vehicles require synchronization of networked sensing elements to build a precise perception of the environment around the vehicle, including other vehicles, objects, hazards, and persons. Tools relied on to achieve the time performance, synchronization, and bounded latency communication for such time sensitive systems to perform is often referred to as time-synchronized networking.

In general, time-synchronized networking or time-sensitive networking (TSN) defines a set of standards (and amendments) with the aim to enable time synchronization and deterministic data delivery in converged networks where time-critical (TC) traffic coexists with other types of traffic. Thus, it is beneficial to provide security for time-synchronized network devices to mitigate the risks associated with disruption in time-synchronized network operation from attacks on the timing of the network.

### BRIEF DESCRIPTION OF THE SEVERAL VIEWS OF THE DRAWINGS

To easily identify the discussion of any particular element or act, the significant digit or digits in a reference number refer to the figure number in which that element is first introduced.

FIG. 1A illustrates an aspect of a time-synchronized network in accordance with one embodiment.

FIG. 1B illustrates an aspect of a TSN for sensors in accordance with one embodiment.

FIG. 1C illustrates an aspect of a TSN for actuators in accordance with one embodiment.

FIG. 2A illustrates an aspect of a TSN in accordance with one embodiment.

FIG. 2B illustrates an aspect of a timing diagram in accordance with one embodiment.

FIG. 3A illustrates an aspect of a TSN in accordance with one embodiment.

FIG. 3B illustrates an aspect of a timing diagram in accordance with one embodiment.

FIG. 4 illustrates an aspect of an apparatus in accordance with one embodiment.

FIG. 5 illustrates an aspect of an apparatus in accordance with one embodiment.

FIG. 6 illustrates an aspect of a system in accordance with one embodiment.

FIG. 7 illustrates an aspect of an alignment check packet (ACP) structure in accordance with one embodiment.

FIG. 8 illustrates an aspect of a packet and frame structure in accordance with one embodiment.

FIG. 9 illustrates an aspect of an operating environment in accordance with one embodiment.

FIG. 10A illustrates an aspect of an operating environment in accordance with one embodiment.

FIG. 10B illustrates an aspect of an operating environment in accordance with one embodiment.

FIG. 10C illustrates an aspect of an operating environment in accordance with one embodiment.

FIG. 11 illustrates an aspect of an early pattern in accordance with one embodiment.

FIG. 12 illustrates an aspect of a late pattern in accordance with one embodiment.

FIG. 13 illustrates an aspect of an operating environment in accordance with one embodiment.

FIG. 14A illustrates an aspect of an operating environment in accordance with one embodiment.

FIG. 14B illustrates an aspect of an operating environment in accordance with one embodiment.

FIG. 14C illustrates an aspect of an operating environment in accordance with one embodiment.

FIG. 15A illustrates an aspect of an operating environment in accordance with one embodiment.

FIG. 15B illustrates an aspect of an operating environment in accordance with one embodiment.

FIG. 15C illustrates an aspect of an operating environment in accordance with one embodiment.

FIG. 16 illustrates a logic flow in accordance with one embodiment.

FIG. 17A illustrates an aspect of a TSN node in accordance with one embodiment.

FIG. 17B illustrates an aspect of a TSN node in accordance with one embodiment.

FIG. 18 illustrates an aspect of a computer-readable medium in accordance with one embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” means either hardware (such as logic circuitry or more generally circuitry or circuit), software, firmware, or some combination thereof.

The present disclosure is generally directed to low-latency techniques to detect, quantify, and localize security attacks on time synchronization and traffic scheduling for systems operating on strict time requirements, such as systems based on time sensitive networks or time-synchronized networks. Cyberattacks against TSN can cause a number of consequences. Besides desynchronizing a time of follower nodes, switches, etc., an attacker can also impact scheduled traffic which is the underlying foundation for bounded latency. Scheduled traffic is defined in various Institute of Electrical and Electronics Engineers (IEEE) standards, such as IEEE 802.1Qbv, for example. It aims at achieving network determinism by defining a schedule where nodes are allowed to transmit information. By computing a schedule for nodes of the network, it becomes possible to precisely define data streams from talker nodes to listener nodes. Each node obeys a precisely determined set of transmit windows so that the goal of bounded latency is achieved. Any time misalignment will subsequently impact the alignment of the scheduled windows (e.g., Qbv windows). This can be due to functional problems, such as theoretical traffic scheduling not performing as supposed to in practice, as well as due to cyberattacks. Thus, it is beneficial to have techniques to comprehensively cover these issues. Further, from a cybersecurity standpoint, it is mandatory to have a mechanism to precisely characterize attacks to properly respond and recover the TSN system.

To enhance security and ultimately reliability of system dependent on tight time synchronization, it is fundamental to detect, localize and quantify the amplitude of attacks in scheduled traffic. Embodiments implement a concept of an alignment check packet (ACP) and diagnostic streams in order to detect and quantify time misalignments due to malfunctions or attacks. Embodiments utilize the fact that a specific diagnostic schedule (e.g., an IEEE 802.1Qbv schedule) along with a diagnostic data stream induces anomalies to yield a unique pattern observed at the receiving end, enabling detection, quantification and localization of attacks. Specifically, time misalignments in the scheduled traffic will manifest as ACPs being delayed at the receiving end. The receiving end may implement a security monitor to analyze such time misalignments to determine whether an anomaly or attack is ongoing. With this capability, it is possible to have a fine-grained and constant monitoring of a system so that any interference caused by an attack is immediately characterized. This enables time-based networks such as a TSN to provide a much higher security level and quality of services than conventional solutions.

Specifically, embodiments monitor a set of specially-crafted diagnostic windows, such as a probe window and a characterization window, for example. In one embodiment, for example, the specially-crafted diagnostic windows are designed for IEEE 802.Qbv scheduled windows. However, embodiments are not limited to IEEE 802.Qbv scheduled windows, and may be implemented with other TSN protocols. A TSN node referred to as a diagnostic stream producer (e.g., a talker node) periodically probes the channel between the transmitter of the diagnostics stream and the remote monitor (e.g., a listener node or security monitor). This approach uses a transmitter executing at the transport level to probe the channel with specific ACPs crafted as User Datagram Protocol (UDP) datagrams. Time misalignments, both early and late in time, of the intermediate switches will manifest as distinct patterns in one or more characterization window time slots (CWTS) of the characterization window which reveal where the problem is located. Upon misalignment, a sequence of size-adjustments is performed in the ACP to analyze what can go through the channel. A difference in bit-size of the standard ACP size and the one that went through represents a total time misalignment of the intermediate switch previously identified. For example, for simplicity, assume an initial ACP size is set to a default length of 410 bits while a modified size that is eventually found to fit the probe window is a length of 400 bits. The difference in bit-size of 10 bits (i.e., 410-400 bits=10 bits) quantifies the total time misalignment attributed to the time misalignment due to a desynchronization event in a TSN. Considered the speed of the channel, the bit-size difference can be converted to difference in time. Additionally, or alternatively, this solution also qualifies the type of misalignment. For example, it may distinguish between situations where a node is late or early in time.

As noted, TSN defines a set of standards (and amendments) with the aim to enable time synchronization and deterministic data delivery in converged networks where time sensitive traffic coexists with other types of traffic. Various standards have been developed to address time-synchronized or time-sensitive communications. By way of example and not limitation, some standards for enabling time-synchronized communications include those promulgated by the IEEE and/or the International Electrotechnical Commission (IEC). For example, IEEE 1588, IEEE 802.1AS, IEEE 802.1Qbv and IEC/IEEE 60802 provide systems and methods for synchronizing device clocks. In one example, IEEE 1588 defines a precision time protocol (PTP) for time synchronization across a network. In another example, IEEE 802.1AS defines a time-sensitive networking protocol referred to as a generic PTP (gPTP) for time synchronization across a network, where time sensitive devices (e.g., clock followers) synchronize to a leader clock (e.g., clock leader). In yet another example, IEEE 802.1Qbv defines time-sensitive networking for deterministic latency through traffic scheduling. In still another example, IEC/IEEE 60802 defines time-sensitive networking profiles for industrial automation. Other examples include a network time protocol (NTP) which is a networking protocol for clock synchronization between computer systems over packet-switched, variable-latency data networks, network time security (NTS) which is a secure version of NTP, and other time-synchronized network protocols. Embodiments are not limited to these examples.

Time synchronization in a TSN employs tight software-hardware interplay. A device (or node) in a TSN may implement a clock manager as a software component and a hardware clock as a hardware component. The clock manager adjusts timing for the hardware clock to ensure synchronization with a common network time for the TSN. In one embodiment, for example, a precision time protocol (PTP) hardware clock (PHC) is periodically adjusted by a PTP for Linux (PTP4L) software module to account for time offset between a clock leader and a clock follower in PTP-synchronized nodes. When a software component receives incorrect time information, such as a time offset bias within messages carrying time synchronization information, the software can misconfigure or mis-control hardware for the PHC, thereby leading to incorrect timekeeping. For instance, attackers located external to a TSN-capable platform along a network path can tamper with messages carrying time information to synchronize the hardware clock. Examples include malicious switches and/or relays tampering with time-related messages, or external attackers injecting messages into the network, which ends up impacting a time of the nodes downstream. Consequently, system and applications depending on TSN capabilities will consume incorrect time. Accordingly, early detection of a corrupted messages and/or software components for a TSN node is beneficial within a TSN.

One conventional solution to address this problem is to implement one or more Intrusion Detection Systems (IDSs) to monitor devices within a TSN to identify any abnormal behavior. An IDS implements software, firmware or hardware to support one or more specialized security functions, such as detecting malicious behavior caused by an attacker. The IDS may be implemented on a TSN node or separate from a TSN node. The IDS receives as input messages containing time information for synchronizing a clock of a TSN node with a network time for the TSN. The IDS analyzes the messages to detect anomalies, such as slight modifications to the time information to cause a TSN node to update an internal clock with a wrong network time. Incorrect time synchronization can cause disruptions in time sensitive applications executing on the TSN node, such as causing collisions between cooperative robotic arms or delaying braking in an autonomous vehicle. When the IDS detects abnormalities in messages carrying time information, the IDS generates an alert and takes action to isolate any affected TSN applications and/or TSN nodes from a compromised TSN node.

While deploying multiple IDSs throughout a TSN improves security for the TSN, each IDS tends to operate on information analyzed by a given IDS. This presents a challenge of developing a comprehensive view of the TSN to recognize patterns, leverage information received from multiple IDSs, and localizing a source of a security attack (e.g., a specific node within the TSN). Further, building a comprehensive picture of the network by a central security server through querying individual IDSs causes an increase in network traffic and latency. Current solutions lack an efficient method to detect, quantify, and localize attacks in time synchronization and traffic scheduling in modern TSNs.

Another solution to address this problem is through deployment of diagnostic packets at a data link layer of the network protocol stack. While effective, this type of solution may necessitate additional complexity during implementation. For example, a schedule of protected windows of transmit nodes may be distributed to neighboring nodes receiving the diagnostics stream. Further, a queuing mechanism of nodes may be modified to drop packets that arrived outside of the window of the transmitter. Still further, intermediate nodes may take receiving ACPs, create its own set, and send them upstream. This would require the switch to do processing, have crypto keys established, and perform other operations. In addition, deployment at the data link layer is complex, and deploying at higher layers (e.g., a transport layer) would cause detection granularity to be coarse. Also, misalignment granularity is in the size of Ethernet Frames, which can be coarse grained depending on a channel speed.

To solve these and other challenges in systems implementing time-synchronized networking operations, embodiments implement low-latency techniques to detect, quantify, and localize security attacks on time synchronization and traffic scheduling for systems operating on strict time requirements, such as TSNs. In general, as TSN nodes desynchronize, they will stop obeying the timing of their transmission windows. Receiving nodes start to receive packets arriving outside of a transmit (TX) window for a transmitter. A monitor checks diagnostic packets received in a diagnostic stream and determines which/how many packets are delayed from assigned time windows. This enables the monitor to detect desynchronization and its amplitude as well as identify where it happened.

More particularly, a TSN typically implements some fundamental procedures (e.g., as defined by a standard) for nodes operating within the TSN, such as time synchronization, traffic scheduling, packet format, reporting procedures, and so forth. For time synchronization, a clock leader has a clock that maintains a network time for a TSN. The clock leader periodically sends time information to clock followers. The clock followers use the time information to adjust local clocks and synchronize the local clocks to match the clock for the clock leader. This process is also followed by any intermediate nodes in the TSN, such as switches or relays. For traffic scheduling, a trusted entity such as a Central Network Controller (CNC) node computes and distributes a traffic schedule to some of the TSN nodes in the TSN. Time-aware traffic shaping grants transmission windows to time-synchronized nodes. Each node has a specific transmission window with a pre-determined cycle and duration. The nodes communicate streams of data (e.g., in the form of messages, packets or frames) using the transmission windows. The data streams flow from “talker nodes” to “listener nodes.”

Attackers may utilize various attack vectors to implement a timing attack on a TSN to desynchronize the TSN. For instance, an attacker may inject malicious software (malware) into a TSN node or fake data into a data stream communicated between TSN nodes. An attack may attempt to tamper with time synchronization procedures for the TSN, thereby causing network nodes such as clock followers and switches, to be desynchronized in relation to a clock leader. The desynchronization causes the network nodes to shift timing windows, due to clock drift, which impacts traffic scheduling. This deteriorates timing guarantees between talker nodes and listener nodes.

Various embodiments may utilize diagnostic information communicated between TSN nodes to detect misalignment of timing windows for the TSN nodes. A TSN node sends a specially-crafted set of packets in one or more diagnostic messages that collectively form a “diagnostic stream” towards a security monitor. The specially-crafted diagnostic packet may be referred to herein individually as an alignment check packet (ACP) or collectively as a set of ACPs. The TSN node may communicate the diagnostic stream with the diagnostic messages using an in-band channel (e.g., interleaved within normal data streams using a priority scheme) of the TSN or an out-of-band channel (e.g., a dedicated diagnostic channel reserved for diagnostic traffic) of the TSN. The monitor may be implemented in a distributed scheme among multiple TSN nodes within the TSN or a centralized scheme by a CNC node for the TSN. When a TSN node sends diagnostic information, it may be generally referred to herein as a “diagnostic stream producer.” When a TSN node receives diagnostic information, it may be generally referred to herein as a “diagnostic stream consumer.” In operation, one or more diagnostic stream producers may send a diagnostic stream of one or more diagnostic messages towards a diagnostic stream consumer. The diagnostic stream consumer may include a monitor that parses the diagnostic stream for diagnostic messages, analyzes any ACPs carried by the diagnostic messages, and determines whether a desynchronization event has occurred for a given TSN node based on results of the analysis.

Embodiments attempt to achieve finer-grained characterization of time misalignment using one or more ACPs while operating in higher layers of the network protocol stack, such as a transport layer or higher. In one embodiment, for example, embodiments tighten a diagnostic window to the length of a single ACP, instantiated as a UDP datagram. Embodiments periodically send diagnostic ACPs to monitors. Upon misalignment, embodiments dynamically adjust an ACP size to methodically probe the channel. If an ACP reaches the monitor within the diagnostic window, then the bit-width difference of the succeeding ACP indicates the amount of time misalignment of the schedule windows (e.g., Qbv windows), whereas the patterns indicates where the time misalignment is occurring.

Embodiments provide several technical advantages relative to conventional solutions. A TSN and time-dependent applications are quite vulnerable if strictly following the standards. In order to provide more resilient TSN-based solutions to customers, cybersecurity gaps are closed. The use of ACPs (both in-band and out-of-band) significantly reduces an amount of latency, overhead, and device and network resources (e.g., memory, compute, bandwidth, etc.) associated with security schemes to protect a TSN. Further, embodiments implement the use of ACPs in a novel manner that reduces or eliminates the complexity introduced by prior solutions. For example, embodiments eliminate distribution of a schedule of protected windows of transmit nodes to neighboring nodes receiving the diagnostics stream. Further, embodiments eliminate modifying a queuing mechanism of nodes in order to drop packets that arrived outside of the window of the transmitter. Still further, embodiments eliminate the intermediate nodes to take receiving ACPs, create its own set, and send them upstream. This avoids the switch to do processing, have crypto keys established, and perform other complex operations. In addition, embodiments are capable of deployment at higher layers of a network protocol stack (e.g., a transport layer), which avoids the complexity associated with using the data link layer, while offering fine-grained detection relative to prior solutions. Also, misalignment granularity is now in the size of a bit while using UDP datagrams, rather than Ethernet Frames, which can be more fine-grained depending on a channel speed.

As a result, embodiments may provide faster and more accurate detection, quantification, and localization of security events occurring in real-time within an apparatus, device or network associated with a TSN. Without the proposed approach, customers will not have the ability to effectively detect attacks, quantify and localize attacks in scheduled traffic in TSNs. With this capability, it is possible to have a fine-grained and constant monitoring of the system so that any interference caused by an attack is immediately characterized. Embodiments enable security products to provide a much higher security level and quality of services than competitors not deploying such an approach. It may be appreciated that other technical advantages exist as well, as will become apparent in the figures, description and claims discussed herein.

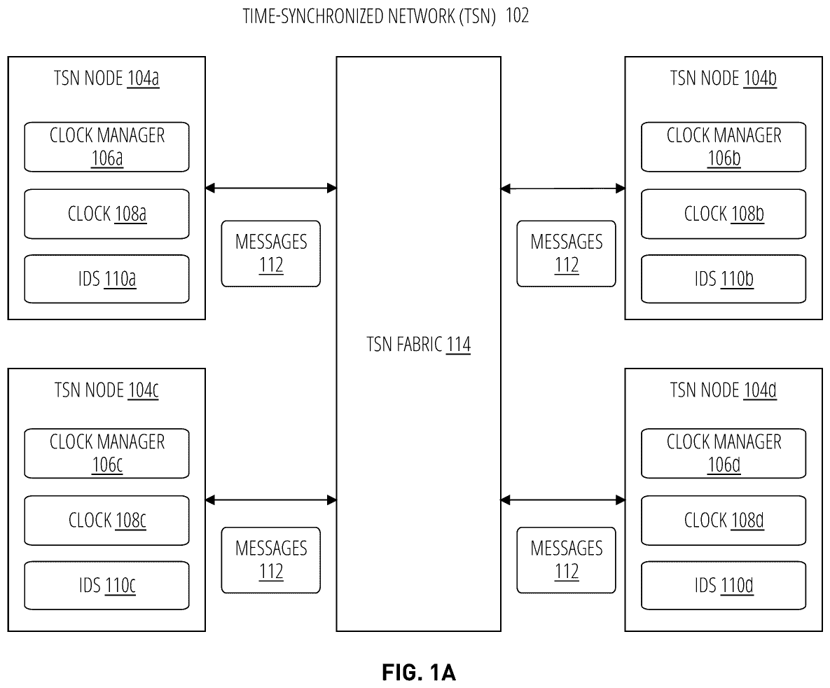

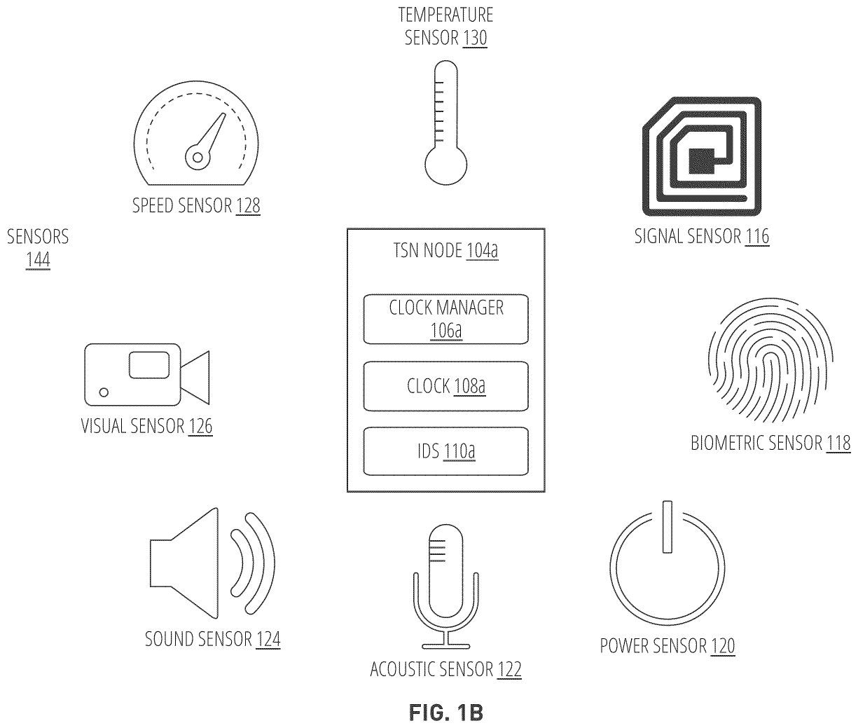

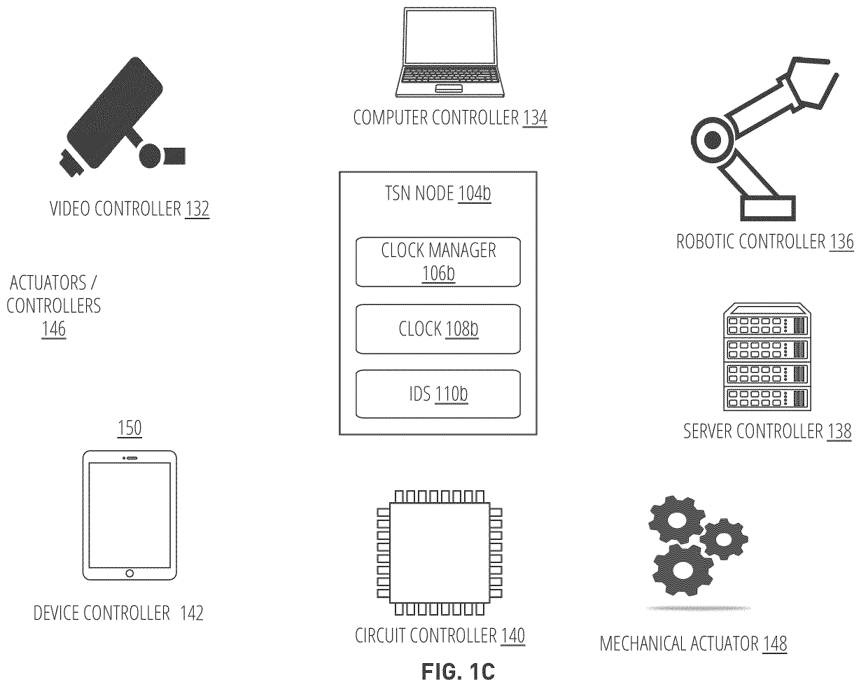

FIG. 1A depicts an exemplary time-synchronized network (TSN) 102 implemented according to a TSN standard (e.g., IEEE 1588, IEEE 802.1AS, IEEE 802.1Qbv, or the like). As depicted, TSN 102 includes various TSN nodes 104, such as TSN nodes 104a-d. The TSN nodes 104 may be implemented as different types of nodes for a TSN, such as an origination node, relay node, switch node, end node, talker node, listener node, diagnostic stream producer, diagnostic stream consumer, and so forth. The TSN nodes 104a-d are communicatively coupled via a TSN fabric 114. The TSN fabric 114 can connect the TSN nodes 104a-d using various types of network topology (e.g., mesh, star, etc.) and various types of communications channels (e.g., wired, wireless, fiber optic, buses, etc.). It is noted that the number of nodes in the TSN 102 is selected for purposes of clarity and not limitation. In practice, the TSN 102 can include any number and combination of nodes (e.g., origination nodes, switches, relay nodes, end devices, etc.).

The TSN nodes 104 can communicate with each other via the TSN fabric 114. For instance, the TSN nodes 104 can send messages 112 to each other over one or more communication channels provided by the TSN fabric 114. The messages 112 can include control information and payload information. One type of control information may include time information. The time information may comprise synchronization messages, time update messages or time follow-up messages (among other time protocol messages) for a time protocol used by the TSN 102.

Each TSN node 104 in the TSN 102 includes various hardware and/or software components. As depicted in FIG. 1A, a TSN 104 includes a clock manager 106, a clock 108 and an intrusion detection system (IDS) 110 (referred to herein as an “IDS” or “detector”). For instance, the TSN node 104a includes a clock manager 106a, a clock 108a and an IDS 110a. The TSN node 104b includes a clock manager 106b, a clock 108b and an IDS 110b. The TSN nodes 104c, 104d are similarly configured. It may be appreciated that these are just a few components for a TSN 104, and the TSN 104 can include other standard components for an electronic device, such as network interfaces, radio transceivers, input/output (I/O) components, memory units, processing circuits, controllers, sensors, actuators, mechanical parts, application software, operating system software, TSN-enabled platforms, and so forth.

In various embodiments, the clock manager 106 is implemented as a software component, and the clock 108 is implemented as a hardware component (e.g., “hardware clock” or “clock circuitry”). The IDS 110 can be implemented as a software component, a hardware component, or a combination of both software and hardware components. Embodiments are not limited in this context.

The clock manager 106 generally manages a time (e.g., clock signals) generated by the clock 108. A key component in clock synchronization mechanisms is the clock manager software. In a time-synchronized network such as the TSN 102, this component tightly interacts with network hardware (e.g., Ethernet/Wi-Fi) to obtain Precision Time Protocol (PTP) message timestamps, as well as with PTP clock hardware to implement suitable phase/frequency corrections in order to synchronize with a clock leader. The clock manager 106 typically implements a “clock servo.” A clock servo is a control algorithm that periodically takes as input some measurement (or estimate) of clock offset to a reference clock, and computes as output either time (e.g., phase) or frequency adjustment to compensate for the given offset.

The clock 108 is generally a hardware clock that implements clock circuitry to generate signals for digital electronics implemented by the TSN node 104. In electronics and especially synchronous digital circuits, a clock signal oscillates between a high and a low state and is used to coordinate actions of the digital circuits. A clock signal is produced by a clock generator. Although more complex arrangements are used, a common clock signal is in the form of a square wave with a 50% duty cycle, usually with a fixed, constant frequency. Circuits using the clock signal for synchronization may become active at either the rising edge, falling edge, or, in the case of double data rate, both in the rising and in the falling edges of the clock cycle. The clock 108 generates clock signals under control of the clock manager 106. The clock 108 can be implemented using any suitable hardware having a timing accuracy for a given device or network. In the TSN 102, the clock 108 can be implemented as a PHC, although other hardware clocks can be implemented as well. Embodiments are not limited in this context.

In normal operation, a network interface (not shown) for a TSN node 104 can receive messages 112 that include time information representative of a network time for the TSN 102. The clock manager 106 can receive the time information from the network interface, analyze the time information, and determine whether time adjustments are to be mode for the clock 108. When time adjustments are to be made, the clock manager 106 generates control information and sends the control information to the clock 108. The clock 108 receives the clock manager control information, and adjusts a parameter for the clock 108, such as a phase or frequency for the clock signals generated by the clock 108.

The IDS 110 generally monitors the clock manager 106 to detect abnormal or malicious behavior of the TSN 102. In general, the IDS 110 is a device or software application that monitors a device, network or systems for malicious activity or policy violations. The IDS 110 may be specifically tuned to detect a timing attack, such as a desynchronization attack, or other TSN specific attack vector. Any intrusion activity or violation is typically reported either to other devices in the same network, an administrator, and/or collected centrally using a security information and event management (SIEM) system. A SIEM system combines outputs from multiple sources and uses alarm filtering techniques to distinguish malicious activity from false alarms. In addition to the TSN node 104, the IDS 110 may be implemented for other devices in the TSN, such as relay nodes 104a-104c, to provide a more comprehensive security solution against attacks.

The IDS 110 can operate in an on-line or off-line mode. When operating in an on-line mode, the IDS 110 examines network traffic in real time. It performs an analysis of passing traffic on the subnet, and matches the traffic that is passed on the subnets to the library of known attacks. For instance, it analyses the message 310 (e.g., a TSN timing message) and applies some rules, to decide if it is an attack or not. Off-line mode typically deals with stored data and passes it through some processes to decide if it is an attack or not. For the offline case, a message may be replicated for offline analysis. It may be replicated in hardware without incurring a memory copy. However, a software solution may copy the message from the queue for later analysis. In either mode, once an attack is identified, or abnormal behavior is sensed, an alert can be sent to a SIEM, a network administrator, or a software application to automatically implement security protocols, such as dropping the message 112, isolating an infected device guarded by the IDS 110, and/or re-configuring one or more network paths for impacted devices in the TSN network.

The IDS 110 can utilize any number of different methods to detect an attack. For instance, the IDS 110 may implement a signature-based method, a statistical anomaly-based method, a stateful protocol analysis method, machine-learning based, or some combination of the four methods. A signature-based IDS monitors packets in the network and compares with pre-configured and pre-determined attack patterns known as signatures. A statistical anomaly-based or machine-learning based IDS monitors network traffic and compares it against an established baseline. The baseline will identify what is “normal” for that network, such as what sort of bandwidth is generally used and what protocols are used. A stateful protocol analysis IDS identifies deviations of protocol states by comparing observed events with defined profiles of generally accepted definitions of benign activity. It will be appreciated that these detection methods are by way of example and not limitation. Other embodiments may use different detection methods as well. The embodiments are not limited in this respect.

FIG. 1B illustrates an example of a TSN node 104a of the TSN 102 designed to control one or more sensors 144. As depicted in FIG. 1B, the TSN node 104 manages various types of sensors 144, such as a signal sensor 116, a biometric sensor 118, a power sensor 120, an acoustic sensor 122, a sound sensor 124, a visual sensor 126, a speed sensor 128, a temperature sensor 130, and so forth. The TSN node 104a may be suitable for implementing a physics-based model for the IDS 110. A physics-based approach as proposed herein utilizes state prediction based on physical models of system dynamics. Unlike conventional information-based security measures, the physics-based model may utilize physical properties of a system, along with controller state estimation, to enable computationally-inexpensive analytical redundancy. For example, a mathematical model-based replica of the system is simultaneously executed to detect attacks.

FIG. 1C illustrates an example of a TSN node 104b of the TSN 102 designed to control one or more actuators and/or host controllers 146. As depicted in FIG. 1C, the TSN node 104b manages various types of actuators/controllers 146, such as a robotic controller 136, a server controller 138, a mechanical actuator 148, a circuit controller 140, a device controller 142, a video controller 132, a computer controller 134, and so forth. As with FIG. 1B, the TSN node 104b shown in FIG. 1C may be suitable for implementing a physics-based model for the IDS 110, as discussed in more detail herein.

In time-synchronized networks, such as the TSN 102 depicted in FIGS. 1A-1C, the TSN nodes 104 to synchronize to a common or shared network time for the TSN 102. For instance, the TSN nodes 104 may operate in accordance with IEEE 802.1AS which implements a hierarchical network to synchronize one or more clock follower (CF) nodes to a clock leader (CL) node (e.g., a grand CL) through relay nodes or switch nodes. Synchronization is performed through communication of time messages, such as the messages 112. The time messages may comprise, for example, time synchronization messages, time update messages and/or time follow-up messages for a PTP.

In some cases, an attacker may simply attempt to disrupt timing of a single TSN node 104 handling beneficial functions, such as disrupting one or both of the TSN node 104a managing the sensors 144 and/or the TSN node 104b managing the actuators/controllers 146. Rather than attempting to disrupt timing for the TSN 102, the attacker may attempt to attack timing of a single TSN node 104 to disrupt key operations for the TSN node 104, such as an electronic control unit (ECU) to control speed sensing for a vehicle or a controller for a robotic arm in a factory.

In other cases, an attacker may attempt to disrupt timing across the TSN 102. To attack or disrupt the TSN 102, an attacker may attempt a timing attack or desynchronization attack to compromise timing for one or more of the TSN nodes 104 in the TSN 102. Assume the TSN node 104c operates as a clock leader (CL) in the TSN 102, and the TSN node 104d operates as a clock follower (CF) in the TSN 102. If an attacker located on a network device (e.g., switch or relay) modifies an attribute on a specific port, then downstream nodes from that network device may suffer a desynchronization event. In this example, if the attacker successfully compromises the TSN node 104c, then the TSN node 104d is vulnerable to a timing attack in the form of receiving messages 112 from the TSN node 104c with erroneous time information. Therefore, it is beneficial to detect and localize an attack as quickly as possible. Furthermore, upon detection, it is beneficial for the TSN 102 to quickly isolate the compromised network device and thereby prevent the desynchronization attack from spreading to other downstream nodes.

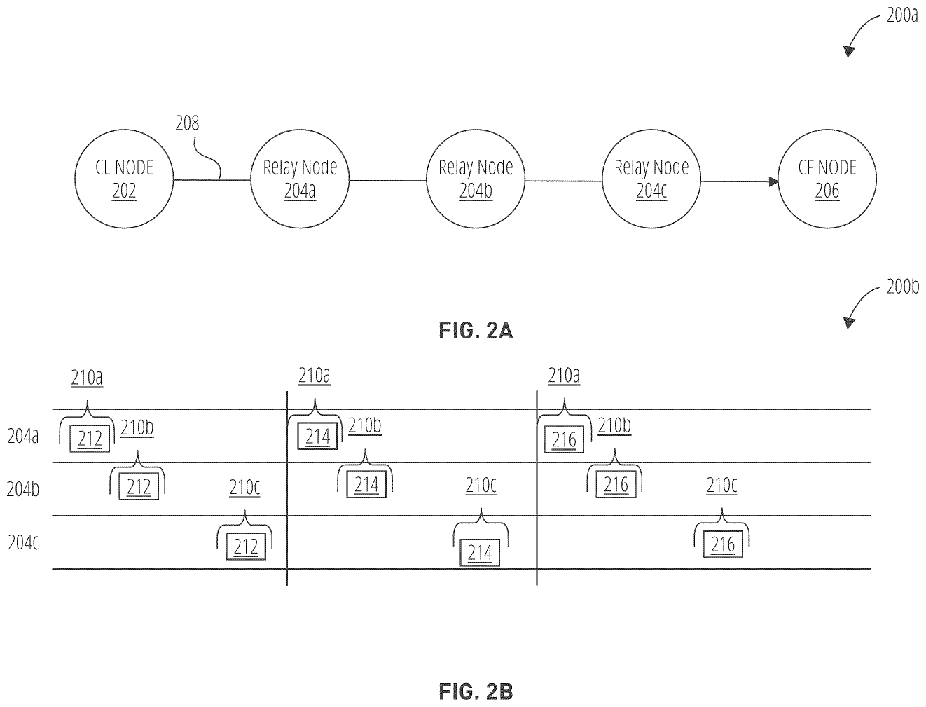

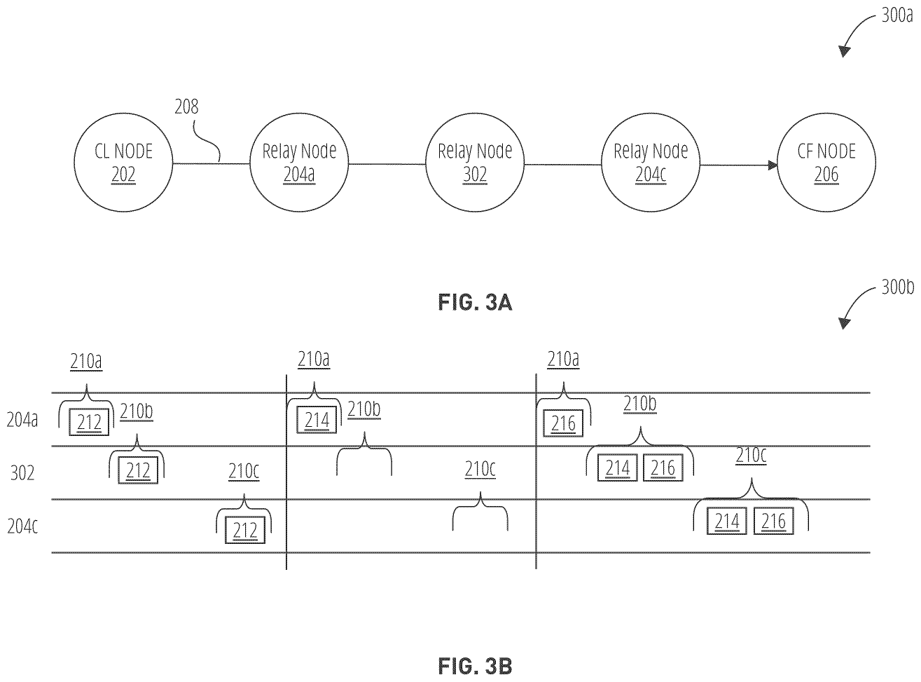

In cases, a time-synchronized network such as the TSN 102 is vulnerable to a timing attack or a desynchronization attack. If a single network node is compromised, it may cause a cascade failure across the TSN 102. An example of such an attack is further described with reference to FIGS. 2A, 2B, 3A and 3B.

FIG. 2A depicts a TSN 200a implemented according to a TSN standard (e.g., IEEE 1588, IEEE 802.1AS, IEEE 802.1Qbv, or the like). As depicted, the TSN 200a includes clock leader node 202, relay nodes 204a, 204b, and 204c, and clock follower node 206, communicatively coupled via communication channel 208. The clock leader node 202 and the clock follower node 206 have a “master/slave” relationship, where the clock leader node 202 is treated as a “master” device and the clock follower node 206 is treated as a “slave” device. The clock leader node 202 includes a clock that maintains a network time for the TSN 102. The clock follower node 206 includes a clock that synchronizes a clock to the network time via one or more of the messages 112. Alternatively, nodes of the network may be implemented as a “talker node” and a “listener node”, respectively. This configuration refers to data transmission, where the talker node transmits data and the listener node listens or receives data. This configuration is used, for example, in scheduled traffic.

Relay nodes 204a, 204b, and 204c are time-aware switching nodes and can be any number of devices in a network arranged to communicate information. A clock leader node 202 sends or originates information and a clock follower node 206 receives or consumes information. Examples of a clock leader node 202 or a clock follower node 206 include devices such as electronic control units in an autonomous vehicle, an industrial system, a medical system, or the like. Additionally, communication channel 208 can be any of a variety of communication channels, including wired or wireless communication channels. In some implementations, devices in the TSN 200a will receive gate control list (GCL) tables. However, in some implementations, clock leader nodes 202 and switching nodes (e.g., relay node 204a, etc.) receive GCL tables while destination devices (e.g., clock follower node 206) do not receive a GCL table.

FIG. 2B depicts a timing diagram 200b depicting communication windows (e.g., Qbv windows, or the like) for switches of TSN 200a based on GCL tables. Typically, GCL tables are generated in a network controller (not shown) and are designed to prioritize time critical (TC) traffic and prevent lower priority traffic from accessing communication channel 208, thus guaranteeing the timely delivery of TC packets within pre-configured time windows. In particular, timing diagram 200b depicts Qbv windows 210a, 210b, and 210c in which packets 212, 214, and 216 are transmitted. It is noted that the communication windows referred to herein are referred to as Qbv windows or protected windows for clarity. However, other standard or techniques for forming protected communication windows to facilitate time synchronization can be used besides Qbv windows. Examples are not limited in this context.

To facilitate transmission of packets (e.g., packet 212, etc.) during protected windows (e.g., Qbv window 210a, etc.), nodes in the TSN 200a are time synchronized and scheduled to transmit TC packets (e.g., packet 212, etc.) using non overlapping protected windows (e.g., Qbv window 210a, etc.). It is to be appreciated that providing latency bounded communication (e.g., as depicted in timing diagram 200b) has tight synchronization of time between nodes in TSN 200a. With such dependency on time synchronization, reliable TSN operation can be disrupted by attacking the timing of the network, sometimes referred to as a desynchronization attack or event.

FIG. 3A depicts a TSN 300a, which is like TSN 200a except that the relay node 302 is depicted as compromised. In particular, the clock (not shown) of relay node 302 can be attacked and compromised, thereby causing the Qbv window 210b associated with relay node 302 to be misaligned with respect to, and even overlap with, the protected windows of the other switch nodes in the data stream path (e.g., along communication channel 208).

FIG. 3B depicts timing diagram 300b illustrating Qbv window 210b misaligned with Qbv window 210a and Qbv window 210c and overlapping with Qbv window 210a. As such, packets (e.g., packet 214 in the figure) arrive too late with respect to the attacked switch protected window (e.g., Qbv window 210b) causing them to be buffered and sent in the next protected window, or alternatively, dropped completely. As a result of the delay in transmitting packet 214, relay node 302 breaks the latency bound of the stream that it is serving and can result in errors or comprise the safety of the system in which the nodes are operating.

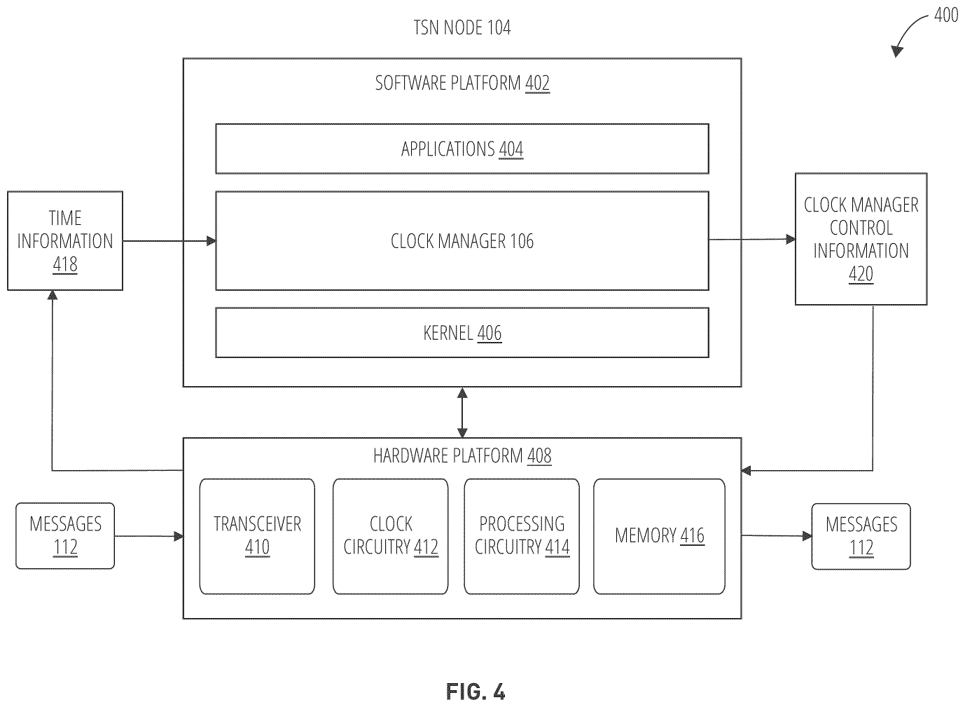

FIG. 4 illustrates a more detailed view of a TSN node 104 that implements one or more TSN protocols or standards. The TSN node 104 may be implemented as any network devices suitable for operation within a TSN, such as TSN 102, 200a, 300a, and so forth. The TSN node 104 may be implemented as part of a vehicle, robot, industrial machine or any other devices suitable for a TSN. The TSN node 104 may be implemented as an origination node 202, relay nodes 204a-204c, relay node 302 and/or end node 206. The TSN node 104 may be implemented as either a clock leader (CL) or a clock follower (CF) in a TSN. The TSN node 104 may include interfaces to communicate information with other TSN nodes 104 in the TSN 102, such as messages 112, for example.

The TSN node 104 may operate in accordance with a timing protocol, such as a precision time protocol (PTP) for IEEE 1588, IEEE 802.1AS, and so forth. For instance, the TSN node 104 may operate in accordance with IEEE 802.1AS which implements a hierarchical network to synchronize clock followers (CFs) to a clock leader (CL) through relays or switch nodes. Synchronization is performed through communication of time messages, such as the messages 112. The time messages may comprise, for example, time synchronization messages, time update messages or time follow-up messages (among others) for a PTP. The time messages may include, among other fields and attributes, a correction field, which accumulates a network residence, and an origin timestamp for a CL. The time message may also comprise, for example, a packet delay message type with additional fields and attributes.

As depicted in FIG. 4, the TSN device 104 may include a software platform 402 and a hardware platform 408. The software platform 402 may include, among other software components, one or more applications 404, a clock manager 106, and a kernel 406. The hardware platform 408 may include, among other hardware components, a network interface such as a transceiver 410, clock circuitry 412, processing circuitry 414 and memory 416.

The processing circuitry 414 may include circuitry or processor logic, such as, for example, any of a variety of commercial processors. In some examples, the processing circuitry 414 may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processing circuitry 414 may include graphics processing portions and may include dedicated memory, multiple-threaded processing and/or some other parallel processing capability. In some examples, the processing circuitry 414 may be an application specific integrated circuit (ASIC) or a field programmable integrated circuit (FPGA). In some examples, the processing circuitry 414 may be circuitry arranged to perform computations related to TSN, such as switching, clock leader, clock follower, routing, security, and so forth.

The memory 416 may include logic, a portion of which includes arrays of integrated circuits, forming non-volatile memory to persistently store data or a combination of non-volatile memory and volatile memory. It is to be appreciated, that the memory 416 may be based on any of a variety of technologies. In particular, the arrays of integrated circuits included in memory 406 may be arranged to form one or more types of memory, such as, for example, dynamic random access memory (DRAM), NAND memory, NOR memory, or the like.

The transceiver 410 may include logic and/or features to support a communication interface. For example, the transceiver 410 may include one or more interfaces that operate according to various communication protocols or standards to communicate over direct or network communication links. Direct communications may occur via use of communication protocols or standards described in one or more industry standards (including progenies and variants). For example, the transceiver 410 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like. In some examples, transceiver 410 may be arranged to support wireless communication protocols or standards, such as, for example, Wi-Fi, Bluetooth, ZigBee, LTE, 5G, or the like.

The TSN node 104 may also include where the network is a controller area network (CAN) or a vehicle area network (VAN). The TSN node 104 may be implemented as a device that manages a sensor, actuator or a controller. The sensors may comprise a speed sensor, a direction sensor, a global positioning system (GPS) sensor, a gas pedal sensor, a brake pedal sensor, a positioning sensor, an object detection sensor, a lane detection sensor, a radar sensor, a light detection and ranging (LIDAR) sensor, an ultrasound sensor, an inertial measurement unit (IMU) sensor, a temperature sensor, a pressure sensor, an altitude sensor, an acoustic sensor, and so forth.

In one aspect, the TSN node 104 may be implemented as a CL or CF for the TSN 102. As previously discussed, the clock manager 106 may ensure that the clock circuitry 412 maintains a network time for the TSN 102. When operating in a CL role, the clock manager 106 may send a message 112 with time information 418 representing a current network time to one or more nodes operating in a CF role for the TSN 102. When operating in a CF role, the clock manager 106 may receive a message 112 from a CL node. The clock manager 106 may use the time information 418 from the message 112 to synchronize a local device time with the current network time maintained by the clock circuitry 412. The clock manager 106 analyzes the time information 418, and determines whether to adjust a parameter (e.g., phase or frequency) of the clock circuitry 412 to synchronize the clock circuitry 412 to the current network time.

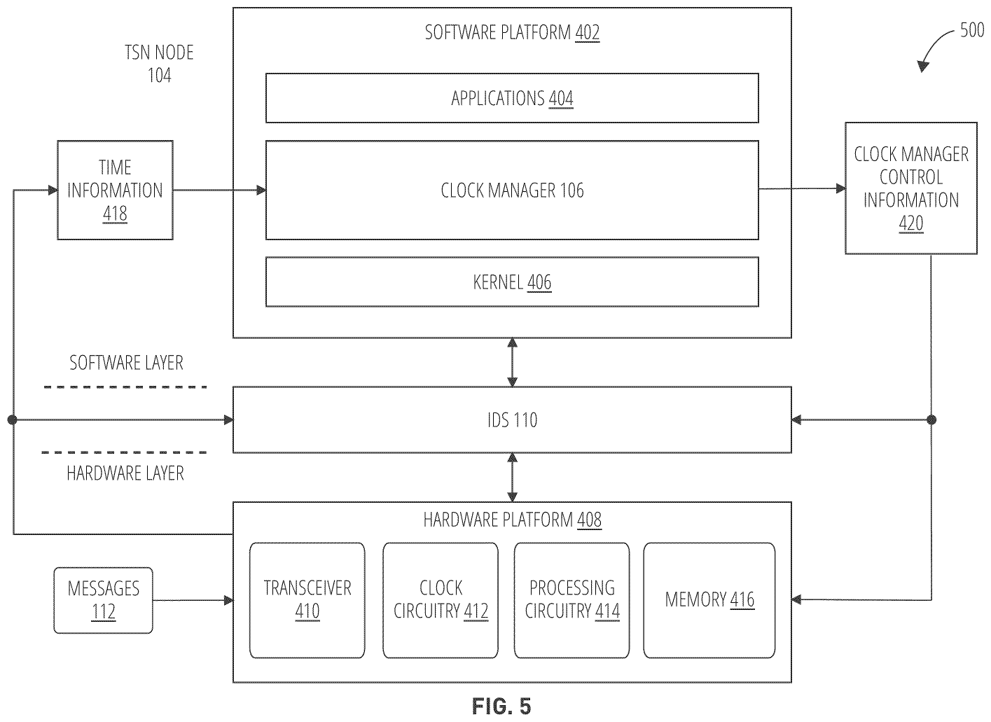

FIG. 5 illustrates an apparatus 500. Similar to the apparatus 400, the apparatus 500 includes a software platform 402 and a hardware platform 408. In addition, the apparatus 500 includes an IDS 110 to monitor a clock manager 106 of the software platform 402. As previously discussed, the IDS 110 generally monitors the clock manager 106 to detect abnormal or malicious behavior of the clock manager 106. More particularly, the IDS 110 monitors the inputs and/or outputs of the clock manager 106, such as consuming the time information 418 sent from the transceiver 410 to the clock manager 106 as input, and the clock manager control information 420 sent from the clock manager 106 to the clock circuitry 412 as output.

As depicted in FIG. 5, the apparatus 500 includes a clock circuitry 412 to implement a hardware clock (e.g., a PHC) for a device, such as a TSN node 104. The apparatus 500 includes a processing circuitry 414 coupled to the clock circuitry 412, the processing circuitry 414 to execute instructions to perform operations for a clock manager 106. The clock manager 106 is operative to receive messages 112 with time information 418 for a network, such as TSN 102. The clock manager 106 generates clock manager control information 420 to adjust the clock circuitry 412 to a network time for the TSN 102. The clock manager control information 420 may comprise one or more parameters to adjust the clock circuitry 412 for the apparatus 500. The one or more parameters may represent, for example, adjustments to a phase or frequency of the clock circuitry 412. For example, the clock manager control information 420 may comprise a phase or frequency adjustment based on a time offset between a reference time and a time maintained by the clock circuitry 412. The reference time is based on the time information 418 in a message 112.

The apparatus 500 further includes an IDS 110 coupled to the processing circuitry 414 and the clock circuitry 412. In one embodiment, the IDS 110 may be implemented as part of a software layer for the apparatus 500, such as the software platform 402. In another embodiment, the IDS 110 may be implemented as part of a hardware layer for the apparatus 500, such as the hardware platform 408. In yet another embodiment, elements of the IDS 110 may be implemented in the software platform 402, while other elements of the IDS 110 may be implemented in the hardware platform 408. Embodiments are not limited in this context.

Although FIG. 5 depicts the IDS 110 implemented as part of the apparatus 500, it may be appreciated that the IDS 110 may be implemented by another apparatus, device or system communicatively coupled to the apparatus 500. For instance, the IDS 110 may be implemented as part of an IDS for the apparatus 500 that is separate from the apparatus 500 or a device other than a device that implements the apparatus 500. For instance, if the apparatus 500 is implemented by a TSN node 104a, the IDS 110 of the apparatus 500 could optionally be implemented in a TSN node 104b. The IDS 110 could also be implemented by an IDS communicatively coupled to the TSN node 104, either directly via a wired or wireless connection, or indirectly via the TSN fabric 114. Embodiments are not limited in this context.

The IDS 110 is operative to consume multiple types of information to detect a security attack. For instance, the IDS 110 can receive and analyze messages 112 for a TSN node implementing the software platform 402 and/or the hardware platform 408. The messages 112 may carry time information for a TSN node, such as an origin time, resident time, link delays, among other types of clock information. The messages 112 may comprise, for example, synchronization messages or “FollowUp” messages. The TSN node retrieves or decodes the time information from the messages 112, and utilize the time information to synchronize an internal local clock with a network time issued by a clock leader or grand clock leader. The IDS 110 can also receive and analyze other types of information, such as clock manager control information 420 in transit from the clock manager 106 of the software platform 402 and the hardware platform 408. For instance, the IDS 110 can consume software control messages, or it can have one or more taps on a hardware bus or signal lines used to communicate electrical signals to the hardware platform 408. The IDS 110 analyzes the messages 112 and/or other types of information, and determines whether to generate an alert or take corrective action for the apparatus 500 based on results of the analysis.

The messages 112 are communicated between TSN nodes at a frequency or rate which can be measured in a number of messages sent or received per unit of time, such as a number of messages sent per second. This is referred to herein as a “message frequency.” The message frequency for transmission of the messages 112, which carry origin time (Sync/FollowUp) and link delay computation (LDC), is typically dependent on the latency requirements of a time-sensitive application. The message frequency is usually calculated during a design phase for a TSN, considering a variety of factors, and instantiated during initialization of a TSN or individual TSN nodes.

Cybersecurity is increasingly becoming a core function within a TSN. Numerous security devices, such as the IDS 110, are deployed throughout a TSN 102. Each deployed IDS 110 monitors a TSN node 104 or group of TSN nodes 104, receiving the messages 112 and analyzing the messages 112 for anomalies or abnormalities indicative of a security attack. Despite increasing security of a TSN, however, the multitude of IDS 110 typically cannot communicate with each other, or a centralized security system such as a SIEM, without introducing a significant amount of network traffic communicated by the TSN. As a result, each IDS 110 is limited to security analysis and inferencing operations based on the network traffic available to the IDS 110. Consequently, an individual IDS 110 does not have a comprehensive view of the TSN 102.

To solve these and other challenges in systems implementing time-synchronized networking operations, embodiments implement low-latency techniques to detect, quantify, and localize security attacks on time synchronization and traffic scheduling for systems operating on strict time requirements, such as TSNs. Various embodiments may utilize diagnostic information communicated between TSN nodes to detect misalignment of timing windows for the TSN nodes. A TSN node sends a specially-crafted set of packets in one or more diagnostic messages that collectively form a “diagnostic stream” towards a monitor. The specially-crafted set of packets may be referred to herein individually as an alignment check packet (ACP) or collectively as a set of ACPs. The TSN node may communicate the diagnostic stream with the diagnostic messages using an in-band channel (e.g., interleaved within normal data streams using a priority scheme) of the TSN or an out-of-band channel (e.g., a dedicated diagnostic channel reserved for diagnostic traffic) of the TSN. The monitor may be implemented in a distributed schemed among multiple TSN nodes within the TSN or a centralized scheme by a CNC node for the TSN. When a TSN node sends diagnostic information, it may be generally referred to herein as a “diagnostic stream producer.” When a TSN node receives diagnostic information, it may be generally referred to herein as a “diagnostic stream consumer.” In operation, one or more diagnostic stream producers may send a diagnostic stream of one or more diagnostic messages towards a diagnostic stream consumer. The diagnostic stream consumer may include a monitor that parses the diagnostic stream for diagnostic messages, analyzes any ACPs carried by the diagnostic messages, and determine whether a desynchronization event has occurred for a given TSN node based on results of the analysis. A more detailed description for an exemplary diagnostic stream producer and a diagnostic stream consumer is discussed below.

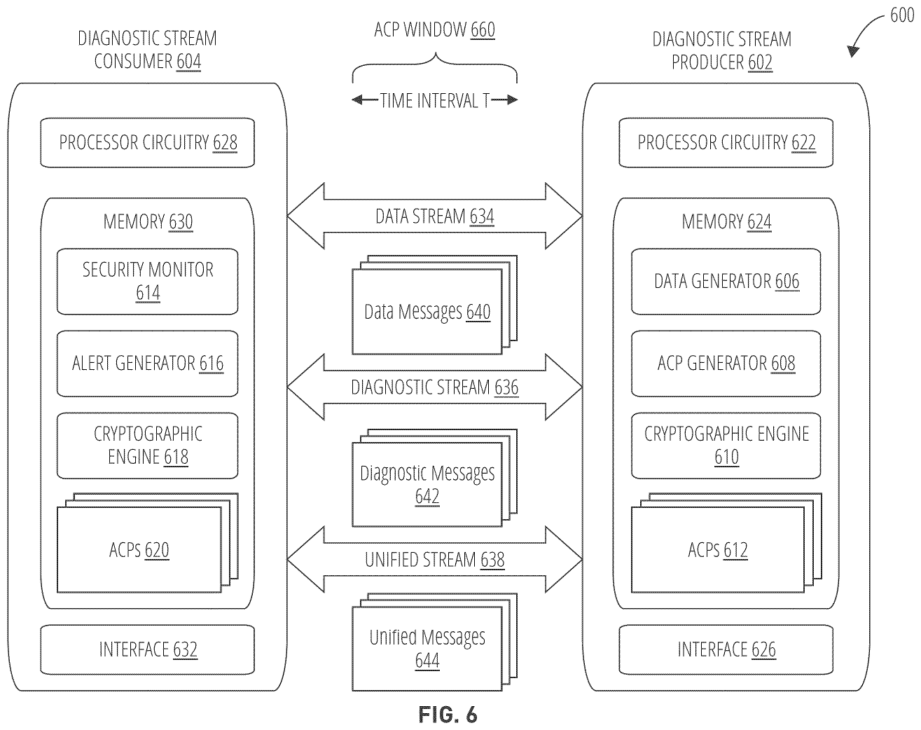

FIG. 6 illustrates a system 600 suitable for a TSN, such as the TSN 102, for example. As depicted in FIG. 6, the system 600 may include a diagnostic stream producer 602 and a diagnostic stream consumer 604. In one embodiment, for example, the diagnostic stream producer 602 and the diagnostic stream consumer 604 are both TSN nodes 104 within the TSN 102. In one embodiment, for example, the diagnostic stream producer 602 may be a talker node within the TSN 102, and the diagnostic stream consumer 604 may be a listener node within the TSN 102. In one embodiment, for example, the diagnostic stream producer 602 may be a TSN node 104 within the TSN 102, and the diagnostic stream consumer 604 may be a central network controller within the TSN 102.

While system 600 depicts a single diagnostic stream producer 602 and a single diagnostic stream consumer 604 for purposes of clarity, it may be appreciated that the system 600 can implement multiple diagnostic stream producers 602 and diagnostic stream consumers 604. Embodiments are not limited in this context.

In general operation, the diagnostic stream producer 602 may produce various types of information that may be communicated to the diagnostic stream consumer 604 over various communications channels implemented by the TSN 102. In one embodiment, for example, the diagnostic stream producer 602 may send a diagnostic message over a dedicated diagnostic stream channel for the TSN 102. In one embodiment, for example, the diagnostic stream producer 602 may send a diagnostic message as part of a message stream channel transporting non-diagnostic messages (e.g., normal TSN and regular data traffic) for the TSN 102. In one embodiment, for example, the diagnostic stream producer 602 may send a diagnostic message in accordance with a priority scheme. For instance, diagnostic messages may be sent with a priority identifier to identify a priority level for the diagnostic message, the priority level to indicate a highest priority level for transport through the TSN 102.

More particularly, as depicted in FIG. 6, the diagnostic stream producer 602 may produce various types of information that may be communicated to the diagnostic stream consumer 604 via a data stream 634 (e.g., data traffic), a diagnostic stream 636 (e.g., diagnostic traffic), or a unified stream 638 (e.g., a combination of data traffic and diagnostic traffic). A data stream 634 may communicate data information for a TSN node via one or more data messages 640. For example, the data information may comprise normal TSN and regular data traffic, such as control information, application information, management information, timing information, protocol information, and so forth. A diagnostic stream 636 may communicate diagnostic information for a TSN node via one or more diagnostic messages 642. For example, the diagnostic information may comprise ACP information, IDS information, and other security information. A unified stream 638 may communicate a combination of data messages 640 and diagnostic messages 642 in a single unified information stream via one or more unified messages 644, such as interleaving data messages 640 and diagnostic messages 642 according to a defined protocol format.

Although some embodiments may be described as a diagnostic stream producer 602 sending diagnostic information via diagnostic messages 642 in a diagnostic stream 636 to a diagnostic stream consumer 604, it may be appreciated that the diagnostic stream producer 602 may send diagnostic information via unified messages 644 in a unified stream 638 to the diagnostic stream consumer 604, and vice-versa. Embodiments are not limited in this context.

In one embodiment, for example, a diagnostic stream producer 602 such as a TSN node 104 may be implemented by a computing apparatus that includes processor circuitry 622, memory 624 and an interface 626. The memory 624 may be communicatively coupled to the processor circuitry 622 and the interface 626. The memory 624 may store instructions that when executed by the processor circuitry 622, causes the processor circuitry 622 to perform one or more operations for the diagnostic stream producer 602. Additionally or alternatively, the operations may be executed by dedicated hardware (e.g., DSP, ASIC, FPGA, circuitry, etc.), or a combination of hardware and software. Embodiments are not limited in this context.

The processor circuitry 622 may execute instructions for a data generator 606. The data generator 606 may prepare a data stream 634 for transmission from the diagnostic stream producer 602 to a diagnostic stream consumer 604 within a time window, such as according to a time schedule distributed by a CNC (e.g., an IEEE 802.Qbv time window), assigned to the diagnostic stream producer 602 in a TSN 102. The data generator 606 may determine an amount of transmit time to send the data stream 634 from the diagnostic stream producer 602 to the diagnostic stream consumer 604 during the time window (e.g., an IEEE 802.Qbv time window) assigned to the diagnostic stream producer 602.

The processor circuitry 622 may execute instructions for an ACP generator 608. In general, the ACP generator 608 may generate one or more ACPs 612 for a given TSN node 104. An ACP 612 is a well-defined packet structure that contains diagnostic information for the TSN node 104. A security monitor may receive an ACP 612 for a TSN node 104, analyze ACP 612, and determine whether the TSN node 104 has been compromised or is under a security attack.

The ACP generator 608 may generate the ACPs 612 and periodically send an ACP 612 during an assigned ACP window 660. In one embodiment, for example, a CNC may assign an ACP window 660 to the diagnostic stream producer 602 prior to sending the diagnostic messages 642 in the diagnostic stream 636. The ACP window 660 is distributed to both the diagnostic stream producer 602 and the security monitor 614 of the diagnostic stream consumer 604. In one embodiment, for example, the ACP window 660 may be set to a same or similar size as the IEEE 802.Qbv time window assigned to the diagnostic stream producer 602.

A size for each of the ACPs 612 is adjustable. Initially, the ACPs 612 may have a size to fit the assigned ACP window 660. For example, the size of the ACPs 612 may be a size of a protocol packet, such as a UDP packet. The ACP window 660 may be defined in accordance with any TSN or network protocols implemented embodiments described herein. As discussed in more detail below, the security monitor 614 is designed to consume the ACPs 612, analyze the ACPs 612, and produce a result indicating whether a TSN node 104 has been compromised.

Attackers may utilize various attack vectors to implement a timing attack on a TSN node 104, such as a diagnostic stream producer 602, in order to desynchronize the synchronized timing of the TSN 102. For instance, an attacker may inject malicious software (malware) into the diagnostic stream producer 602 or inject fake data into timing information received by the diagnostic stream producer 602 in order to cause a local clock 108 for the diagnostic stream producer 602 to maintain a local time that is different from the network time of the TSN 102. The desynchronization causes the diagnostic stream producer 602 to shift its assigned schedule window, due to clock drift, which impacts traffic scheduling. This deteriorates timing guarantees between the diagnostic stream producer 602 and other TSN nodes 104 in the TSN 102, such as the diagnostic stream consumer 604, for example. Another example of an attack is when other TSN nodes 104 along a network path to the security monitor 614 (e.g., intermediate nodes) are impacted and therefore a misalignment of the windows will occur at these TSN nodes 104.

The diagnostic stream producer 602 may generate diagnostic information that can be used by the diagnostic stream consumer 604 to detect misalignment of an ACP window 660 for the diagnostic stream producer 602. The diagnostic stream producer 602 may send specially-crafted ACPs 612 in one or more diagnostic messages that collectively form a diagnostic stream 636 towards the diagnostic stream consumer 604. The ACP generator 608 of the diagnostic stream producer 602 may generate an ACP on a periodic, aperiodic, or on-demand basis. The diagnostic stream producer 602 may communicate diagnostic messages 642 with one or more of the ACPs 612 using an in-band channel such as the unified stream 638 (e.g., interleaved within normal data streams using a priority scheme) of the TSN 102 or an out-of-band channel such as the diagnostic stream 636 (e.g., a dedicated diagnostic channel reserved for diagnostic traffic) of the TSN 102. The diagnostic stream consumer 604 may include a security monitor 614 that parses the diagnostic stream 636 or the unified stream 638 for the diagnostic messages 642, analyzes any of the ACPs 612 carried by the diagnostic messages 642, and performs security inferences to determine whether a desynchronization event has occurred for the diagnostic stream producer 602 based on results of the analysis.

It may be possible, however, for an attacker to intercept the diagnostic messages 642 in order to modify the set of ACPs 612 or forge a fake set of ACPs 612. In order to enhance security for ACPs 612, each ACP 612 is designed to be unique, bounded to a TSN node 104, and unforgeable. An ACP 612 is made unique and unforgeable using a pair-wise cryptographic key shared between a TSN node 104 and a security monitor 614. A keyed hash binds the node number and the packet sequence number. Further, each ACP has a unique identifier with a defined minimum size or bit-width. Forgery can happen during message relay within a resident time. After relaying a message, freshness of the identifier forces a brand-new forgery attempt.

The ACP generator 608 may generate an ACP from a set of ACPs 612 for the diagnostic stream producer 602. During normal or benign conditions for the TSN 102, the ACP generator 608 may determine an initial size for each of the ACPs 612 by examining an ACP window 660 assigned to the diagnostic stream producer 602, and it sets an initial or default size for the ACP to fit within the ACP window 660. During attack conditions, the ACP generator 608 may modify the initial size for the each of the ACPs 612 in order to quantify an amount of time misalignment caused by a desynchronization event from a desynchronization attack.

In one embodiment, the diagnostic stream producer 602 may transmit one or more diagnostic messages 642 using a dedicated diagnostic stream 636. Each of the diagnostic messages 642 may carry one or more ACPs 612. In this case, the ACP generator 608 may determine a size for each of the ACPs 612 by examining the ACP window 660. For example, assume the diagnostic stream producer 602 is assigned an ACP window 660 of a time interval T, where Tis any positive integer. The ACP generator 608 will generate each of the ACPs 612 so that it may fit within the ACP window 660 of time interval T.

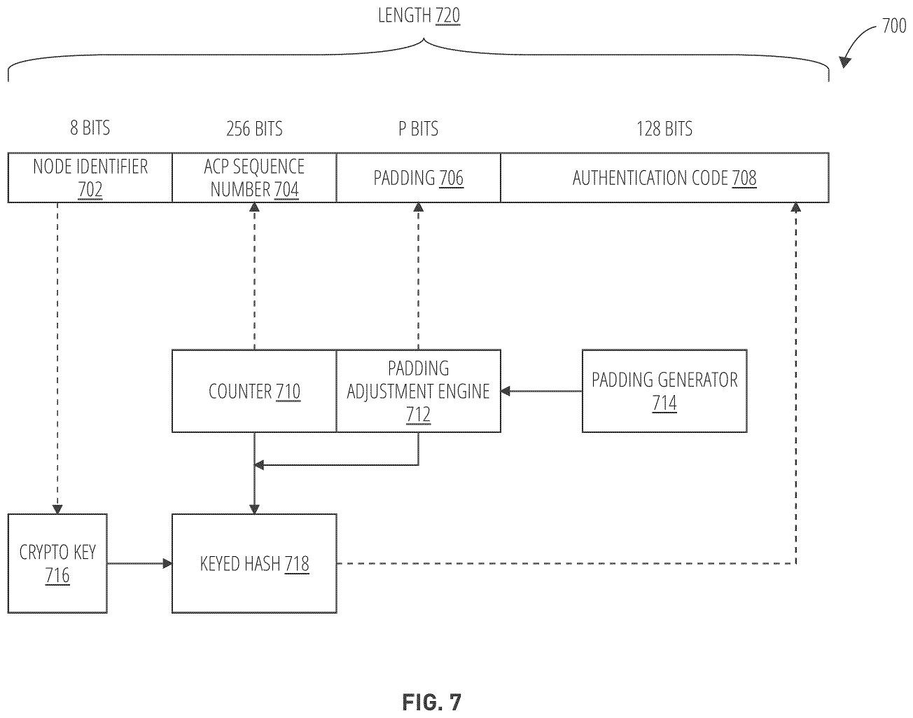

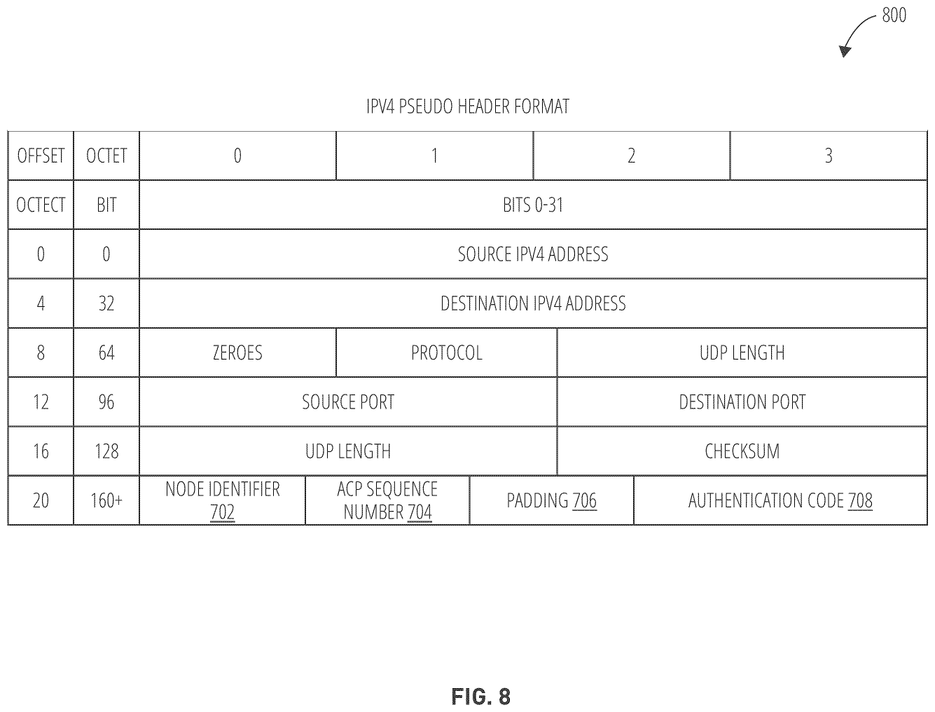

An ACP 612 has a well-defined packet structure designed to carry diagnostic information associated with the diagnostic stream producer 602. An ACP 612 may be sent as a separate packet and/or frame with a defined structure, such as discussed with reference to FIG. 7, for example. Alternatively, an ACP 612 may be sent as part of another packet, such as a payload for a User Datagram Protocol (UDP) datagrams or Internet Protocol (IP) frames, such as discussed with reference to FIG. 8.

Each ACP 612 may include diagnostic information associated with the diagnostic stream producer 602. The diagnostic information may comprise a node identifier for the diagnostic stream producer 602, an ACP sequence number, an authentication code for the diagnostic stream producer 602. The diagnostic information may optionally include security information, measurements, key performance indicators (KPIs), status information, etc., from any monitoring hardware or software that is assigned to monitor the diagnostic stream producer 602.

The diagnostic information may comprise a node identifier. A node identifier is a unique identifier for a TSN node 104. The node identifier indicates a TSN node that originates a given ACP 612. For example, assume a TSN 102 comprises a set of TSN nodes 1 through n, where n represents any positive integer. Further assume the TSN 102 comprise five TSN nodes (e.g., n=5). Each TSN node is assigned a node identifier from 1 to 5. If a TSN node 3 generates a set of ACPs 612 that is part of a diagnostic message 642, a diagnostic stream producer 602 or a diagnostic stream consumer 604 that receives the diagnostic message 642 may use the node identifier to determine that ACP 612 was generated by the TSN node 3. In one embodiment, for example, the node identifier is a unique identifier for the diagnostic stream producer 602, the node identifier having a defined minimum size (or bit-width) to prevent forgeries.

In various embodiments, the diagnostic information typically comprises ACPs 612 sent from the diagnostic stream producer 602 to the diagnostic stream consumer 604 on a per-stream basis. A monitor analyzes ACP 612 for time anomalies using a set of one or more diagnostic windows. In some cases, however, multiple ACPs 612 are sent from the diagnostic stream producer 602 to the diagnostic stream consumer 604 to support probe operations, as discussed further below.

In one embodiment, for example, a first ACP 612 is sent per stream to the diagnostic stream consumer 604. When the monitor determines that the first ACP is outside of a diagnostic window (e.g., a probe window or a characterization window), it may initiate a request to send additional ACPs in the set of ACPs 612 to support a probe operation, as discussed further below. The first ACP and the additional ACPs may be given an ACP sequence number to keep track of how many ACPs are sent from the diagnostic stream producer 602 and in which order.

The diagnostic information may comprise an authentication code. In one embodiment, for example, the authentication code may be generated by a cryptographic key used by the diagnostic stream producer 602 and the diagnostic stream consumer 604 of the TSN 102. The authentication code may represent any cryptographically secure authentication code generated in accordance with a given cryptographic scheme, such as symmetric-key schemes, asymmetric-key schemes, public key encryption schemes, Rivest-Shamir-Adleman (RSA) public key encryption schemes, and so forth. Embodiments are not limited to a particular cryptographic scheme.

For example, the processor circuitry 622 may execute instructions for a cryptographic engine 610. The cryptographic engine 610 may generate authentication codes for the diagnostic stream producer 602. The cryptographic engine 610 may receive as input a set of cryptographic information, such as a symmetric or asymmetric security key, and output the authentication codes based on the security key. The ACP generator 608 may receive as input the authentication codes from the cryptographic engine 610, and insert an authentication code into the ACPs 612 associated with the diagnostic stream producer 602.

Once the ACP generator 608 generates ACP 612, the ACP generator 608 may insert the ACP 612 into a diagnostic stream 636. For instance, the ACP 612 may be sent as an individual message, where each ACP 612 is sent in sequence to form the diagnostic stream 636. If misalignment occurs, ACP 612 will be delayed along the way, and the time misalignments form a timing pattern which is how the security monitor 614 is able to determine an amount of delay and a source of the delay using the security monitor 614. Alternatively, the ACP generator 608 may insert ACP 612 into a diagnostic message 642. A diagnostic message 642 may comprise a single ACP 612, and in some cases, may include other types of diagnostic information. Embodiments are not limited in this context.

An interface 626 may send the diagnostic messages 642 with ACP 612 in a diagnostic stream 636 and/or a unified stream 638 from the diagnostic stream producer 602 to the diagnostic stream consumer 604 within the time window assigned to the diagnostic stream producer 602.

In some cases, the diagnostic stream producer 602 may have an IDS 110 monitoring operations for the diagnostic stream producer 602. In such cases, the diagnostic information may optionally comprise security information from the IDS 110 associated with the diagnostic stream producer 602. The diagnostic stream producer 602 may determine whether security information has been generated for the diagnostic stream producer 602 by the IDS 110, and retrieve the security information from the IDS 110. The diagnostic stream producer 602 may add the security information to one or more ACPs 612, or in a different portion of the diagnostic message 642 (e.g., a different field), and send the diagnostic message 642 with the set of ACPs 612 and the security information from the IDS 110 from the diagnostic stream producer 602 to the diagnostic stream consumer 604 within the residual time for the time window assigned to the diagnostic stream producer 602.

In one embodiment, for example, a diagnostic stream consumer 604 such as a TSN 104 may be implemented by a computing apparatus that includes processor circuitry 628, memory 630 and an interface 632. The memory 630 may be communicatively coupled to the processor circuitry 628 and the interface 632. The memory 630 may store instructions that when executed by the processor circuitry 628, causes the processor circuitry 628 to perform one or more operations for a diagnostic stream consumer 604. Additionally or alternatively, the operations may be executed by dedicated hardware (e.g., DSP, ASIC, FPGA, circuitry, etc.), or a combination of hardware and software. Embodiments are not limited in this context.

The processor circuitry 628 may execute instructions for a security monitor 614. The security monitor 614 may receive one or more diagnostic messages 642 from a diagnostic stream 636 or a unified stream 638 via the interface 632. As described with reference to the diagnostic stream producer 602, a diagnostic message 642 may comprise of ACP 612 for a TSN node 104, such as the diagnostic stream producer 602. For example, ACP 612 may include a first node ACP associated with a first TSN node 104 in the TSN 102. The first TSN node 104 may comprise, for example, a diagnostic stream producer 602. The first node ACP may carry diagnostic information associated with the first TSN node 104. For example, the diagnostic information may comprise, among other types of information, a node identifier for the first TSN node 104, an ACP sequence number for the first TSN node 104, and an authentication code for the first TSN node 104. The first node ACP may have a defined size known by the diagnostic stream consumer 604.

The security monitor 614 of the diagnostic stream consumer 604 examines the received ACP 612 from the diagnostic stream producer 602. It analyzes a first diagnostic window, such as a probe window, for ACP 612 to determine whether there is indicia of a time misalignment somewhere along the network path between the diagnostic stream producer 602 and the diagnostic stream consumer 604. At this stage, the security monitor 614 may suspect the TSN 102 is under attack. Under attack conditions, the security monitor 614 may send control directives to the ACP generator 608 to alter a size for the set of ACPs 612 to support a probe operation. This may include adding padding bits to ACP 612 to increase a length for ACP 612, or removing padding bits from ACP 612 to decrease a length for the ACP 612. This may continue through several iterations or cycles until the security monitor 614 finds a size for ACP 612 that fits within the first diagnostic window used by the security monitor. The difference in size between the initial size of ACP 612 and the modified size of ACP 612 may represent an amount of time misalignment caused by a desynchronization event.

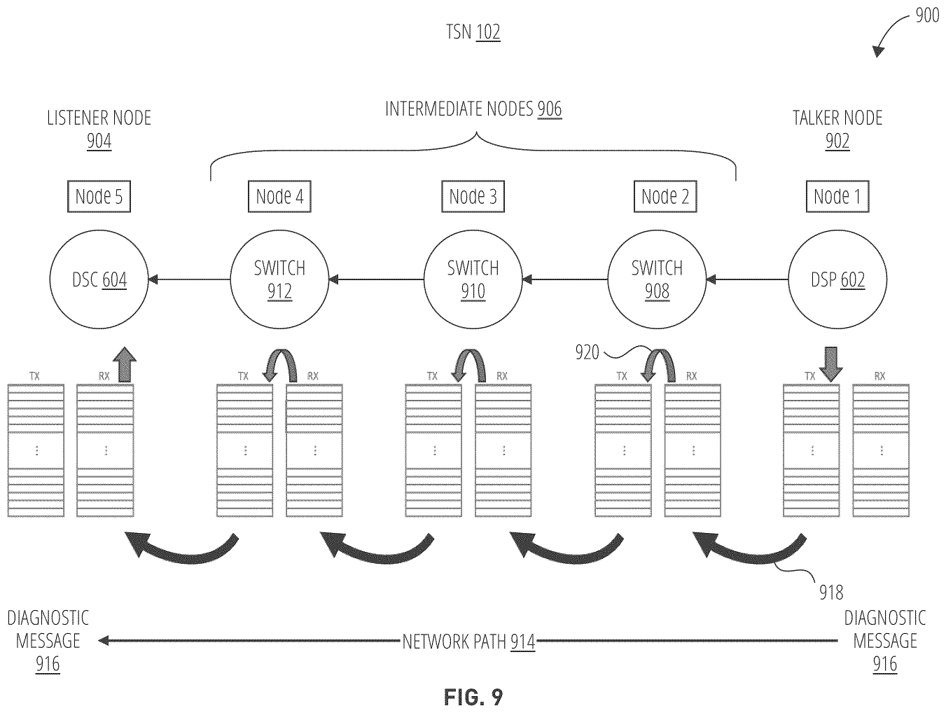

The security monitor 614 may use a second diagnostic window, such as a characterization window, for the ACPs 612 to determine which intermediate node between along the network path between the diagnostic stream producer 602 and the diagnostic stream consumer 604 is the source of the time misalignment quantified by the first diagnostic window. The quantification and identification operations of the security monitor 614 are discussed further with reference to FIG. 9.

The processor circuitry 628 may execute instructions for a cryptographic engine 618 to authenticate the first node ACP based on the authentication code. The cryptographic engine 618 may receive as input the authentication code and a set of cryptographic information, such as a symmetric or asymmetric security key, and output a verification that the authentication code is based on the security key. The security monitor 614 may receive as input the verification or authentication from the cryptographic engine 618.

In some cases, authentication does not verify. For example, this can happen when a forgery attack is attempted. The forged ACPs can indicate where the forgery is happening. TSN nodes 104 closer to the security monitor 614 would have their ACPs 612 authentication verified, but at some depth of the network, the ACPs will start not to verify due to forgery. This also indicates that an anomaly, likely an attack, is happening. In some cases, it is even possible to distinguish an anomaly from an attack. In an anomaly, usually some packets are corrupted and do not verify. In an attack, the adversary may try to forge as much as possible to maximize the likelihood of a forged packet to go through. However, the attacker may attempt to affect a selected number of ACPs, and that would appear like an anomaly to the security monitor 614.

Once authentication is complete, the security monitor 614 may identify which node that has shifted (e.g., desynchronized) in time based on a timing pattern of the arriving ACPs 612 within the probe window and/or a characterization window. The security monitor 614 may use the probe window and/or the characterization window to detect, localize, and quantify time misalignments caused by a time-based attack on the TSN 102, such as a desynchronization event caused by a desynchronization attack, for example.

The processor circuitry 628 may execute instructions for an alert generator 616. The alert generator 616 may receive the control signal indicating an attack on the first TSN node 104 from the security monitor 614, and generate an alert for the TSN 102 indicating the first TSN node 104 is under a security attack. The diagnostic stream consumer 604 may send an alert message to a CNC or a SIEM via the interface 632. The CNC or SIEM may initiate security procedures in response to the security attack, such as isolating the first TSN node 104, updating routing tables for other TSN nodes 104 within the TSN 102 (e.g., switch nodes, relay nodes, etc.), informing neighboring TSN nodes of the attack on the first TSN node 104, and other corrective actions.

FIG. 7 illustrates an exemplary ACP structure 700. The ACP generator 608 may generate the ACPs 612, with each ACP having the ACP structure 700, for a diagnostic stream producer 602.

As depicted in FIG. 7, the ACP structure 700 has four information fields. The first information field is for a node identifier 702 and it comprises a length of 8 bits. The second information field is for an ACP sequence number 704 and it comprises a length of 256 bits. The fourth information field is for a padding 706 and it comprises a length of P bits, where P represents any positive integer. The fourth information field is for an authentication code 708 and it has a length of 128 bits. The four information fields have a combined total length 720 of 392 bits+P bits. It may be appreciated that the number of fields and length of each field is given by way of example and not limitation, and a different number of fields and field lengths can be used for a given implementation. Embodiments are not limited in this context.

Each ACP 612 is generated to be unique, bounded to a TSN node 104, and unforgeable using a cryptographic algorithm. In one embodiment, for example, a pair-wise crypto key 716 is shared between a TSN node 104 and a security monitor 614. The crypto key 716 is used as a first input to a key hash algorithm. The entire ACP 612, absent the authentication code 708, is used as a second input to the key hash algorithm. The key hash algorithm produces a keyed hash 718 from the first and second inputs and produces the message authentication code to be inserted in the ACP.

The padding adjustment engine 712 may generate a padding value for an ACP, which in turn adjusts a total length for the ACP. The padding adjustment engine 712 dynamically adjusts the padding value to methodically probe the channel in response to control directives from the security monitor 614 to allow the security monitor 614 to determine an amount of time misalignment of the schedule windows, as discussed further below. The padding adjustment engine 712 may generate the padding value using input from a padding generator 714. Examples for the padding generator 714 may include a counter, a pseudo-random number (PRNG), a random number generator (RNG), physical property of a hardware component from a sensor, or any other technique to create random bits.

The key hash algorithm receives the three inputs and outputs a keyed hash 718. The keyed hash 718 binds the node identifier 702 for a TSN node 104 and an ACP sequence number 704. A security monitor 614 can use the keyed hash 718 to authenticate and verify each ACP of a set of ACPs 612.

Some embodiments can avoid exhausting a count value of ACP numbers by changing the cryptographic key on a periodic, aperiodic or on-demand basis. This prevents a condition where a TSN node 104 or TSN 102 runs out of sequence numbers. Cryptographic keys are changed periodically, following well-known specifications, such as those from the National Institute of Standards and Technology (NIST). Re-keying operations may also be triggered when a system is potentially running out of ACP sequence numbers.

Embodiments are specifically-designed to protect a TSN 102 from an attacker attempting to compromise one or more TSN nodes 104 from multiple attack vectors. For instance, assume the attacker attempts to block traffic or does not forward traffic. The attacker reveals itself, as traffic from the nodes pertaining to the stream path is expected by the security monitor 614. In another example, assume the attacker attempts to drop additional packets. The dropping of packets indicates an abnormality, and that abnormality reveals that the attacker is attempting to compromise the TSN 102. Therefore there is no incentive for the attacker to drop packets, as that would be immediately flagged as an abnormality. In yet another example, assume the attacker attempts to inject new packets into the TSN 102. In this case, the attacker cannot forge ACPs 612 as any forged ACP will be detected via the cryptograph scheme used by the TSN nodes 104 and the security monitor 614.

FIG. 8 illustrates a packet and frame structure 800 for the ACPs 612. In one embodiment, for example, the packet and frame structure 800 may be implemented as a UDP datagram with an Internet Protocol Version 4 (IPv4) or Internet Protocol Version 6 (IPv6) header format.

As shown in FIG. 8, the packet and frame structure 800 may comprise a standard UDP datagram with multiple information fields, such as a source IPv4 address, a destination IPv4 address, zeroes, protocol identifier, UDP length, a source port, a destination ports, another UDP length, and a checksum. The bottom part of the packet and frame structure 800 is a data payload field. The data payload field may carry the ACPs 612 having the ACP structure 700 as described with reference to FIG. 7, such as a node identifier 702, an ACP sequence number 704, a padding 706, and an authentication code 708. Specific dimensions for a set of ACPs 612 may be determined based on a padding value for the padding 706.

Although embodiments are discussed with reference to a UDP datagram as a packet and frame structure 800 for the ACPs 612, it may be appreciated that any packet and frame structure 800 may be implemented for any protocol layer of a protocol stack suitable for implementation by the TSN 102, such as the Open Systems Interconnection (OSI) model, TCP/IP model, and so forth. Embodiments are not limited in this context.

FIG. 9 illustrates an operating environment 900 for an exemplary TSN 102 implementing one or more TSN protocols for the system 600. The TSN 102 may comprise 5 TSN nodes labeled node 1, node 2, node 3, node 4 and node 5. Node 1 may comprise a diagnostic stream producer 602. Node 5 may comprise a diagnostic stream consumer 604. Node 2 through node 4 may comprise intermediate nodes 906 implemented as time-synchronized switches. For example, node 2 may comprise a switch 908, node 3 may comprise a switch 910, and node 4 may comprise a switch 912.

As depicted in FIG. 9, the diagnostic stream producer 602 may operate as a talker node 902 and the diagnostic stream consumer 604 may operate as a listener node 904. Additionally, the diagnostic stream consumer 604 may include a monitor, such as security monitor 614. Alternatively, the diagnostic stream consumer 604 may be protected by an IDS 110 implementing the security monitor 614.

The diagnostic stream producer 602 may generate a diagnostic message 916 for transport as a diagnostic stream 636 to the diagnostic stream consumer 604 over a network path 914 that includes a set of intermediate nodes 906 such as the switch 908, the switch 910 and the switch 912. The diagnostic message 916 may include one or more ACPs 612. The intermediate nodes 906 forward the diagnostic message 916 along the network path 914 using receive (RX) queues to receive the ACPs 612 and transmit (TX) queues to transmit the ACPs 612. Each hop along the network path 914 may introduce an amount of expected latency or delay, such as link delay (LD) 918 and switch delay (SD) 920. LD 918 is naturally occurring propagation delays of the signal in the network media. SD 920 is naturally occurring internal delay as each switch processes the ACPs 612 for forwarding. Consequently, the diagnostic stream producer 602 may transmit the ACPs 612 in a single schedule window assigned to it and the diagnostic stream consumer 604 may receive the ACPs 612 in multiple sequential schedule windows assigned to it. Accordingly, it may be difficult for the diagnostic stream consumer 604 to ascertain whether the accumulated delay occurs naturally or is due to a desynchronization attack.

Embodiments implement a schedule that opens a direct channel between the talker node 902 and the listener node 904 (e.g., with a security monitor 614). Under benign conditions, ACPs 612 are forwarded, and nothing is left behind. However, whenever an attack is launched and misalign one node (or multiple of nodes), a time window will close sooner or later than expected. As a consequence, the diagnostic stream 636 will suffer an impact that indicates an ongoing anomaly. More precisely, under the attack conditions the ACPs 612 will start to be buffered and lagging behind. The security monitor 614 at the receiving end will notice one or more of the ACPs 612 of the diagnostic stream 636 do not arrive in their assigned time windows, which informs the security monitor 614 that a time misalignment is occurring in the scheduled traffic in one or more of the nodes 1-5.

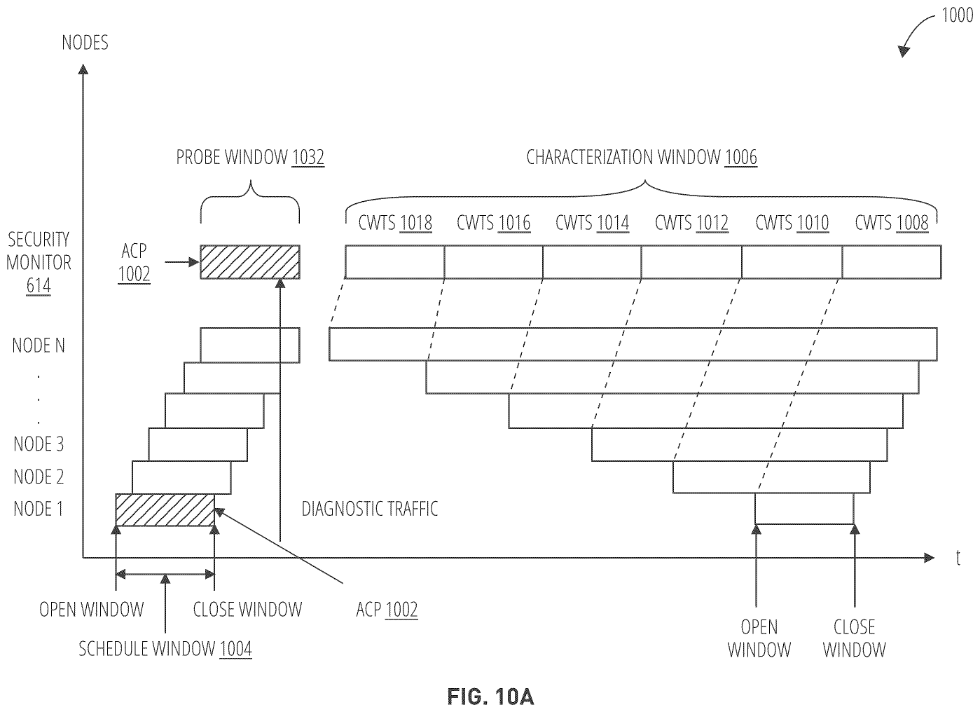

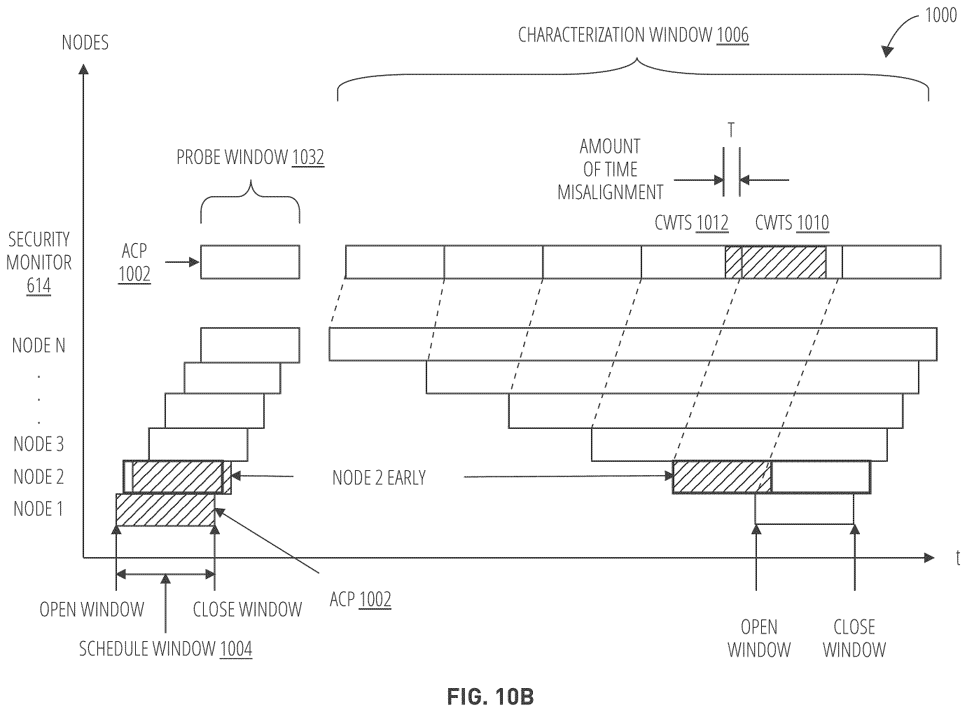

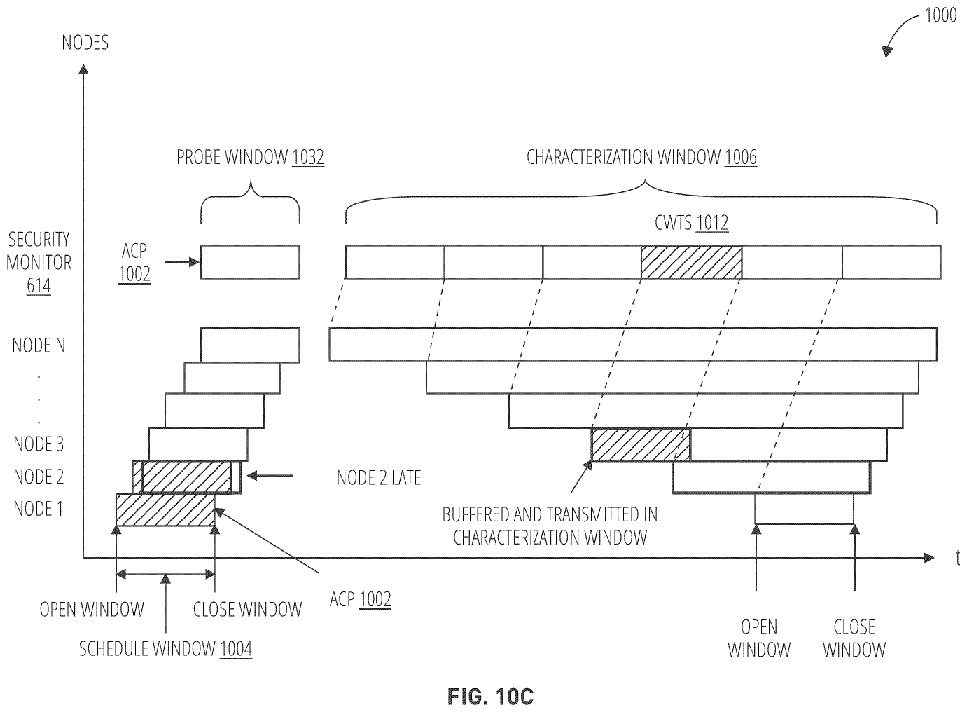

FIG. 10A illustrates a first example of an operating environment 1000. The operating environment 1000 is an example of a diagnostic stream producer 602 transmitting an ACP 1002 from a transmit queue to a receive queue for a diagnostic stream consumer 604. The diagnostic stream consumer 604 receives the ACP 1002 in the receive queue. A security monitor 614 analyzes a pattern for the received ACP 1002 to detect any time anomalies. The security monitor 614 may be implemented as part of the diagnostic stream consumer 604, an IDS for the diagnostic stream producer 602, or a CNC for the TSN 102.

As depicted in FIG. 10A, a TSN node 1 operates as a diagnostic stream producer 602 and it generates an ACP 1002 according to an initial size to ensure a tight fit within an ACP window 660. In one embodiment, for example, the initial size of the ACP 1002 is the length of a single UDP datagram. The diagnostic stream producer 602 transmits the ACP 1002 as part of one or more diagnostic messages 642 of a diagnostic stream 636 to the diagnostic stream consumer 604. Further, the diagnostic stream producer 602 transmits the ACP 1002 in a schedule window 1004 assigned to the diagnostic stream producer 602 by a central network controller (CNC).

The CNC for the TSN 102 employs a scheduling protocol, such as the IEEE 802.Qbv protocol, to schedule time windows for nodes. This protocol is specifically designed to meet the stringent timing requirements of TSN applications, such as industrial automation, automotive systems, or audio/video streaming. The CNC acts as the time synchronization master for the network, ensuring that nodes share a common notion of time. It manages the allocation of time slots, known as time windows, to each TSN node in the TSN 102. To schedule time windows using the IEEE 802.Qbv protocol, the CNC utilizes a time-based scheduling algorithm. It assigns specific time slots to each node, allowing them to transmit their time-sensitive data within their allocated time windows. These time slots are structured in a deterministic manner, enabling nodes to accurately predict when they can access the network and transmit their data. The scheduling process involves coordination between the CNC and individual nodes. The CNC broadcasts the schedule, specifying the time at which each node is granted access to the network. Upon receiving this schedule, each node aligns its local clock with the network's time reference and ensures that it transmits data strictly within its designated time window. By scheduling time windows, the CNC effectively manages the network's traffic and ensures that time-critical data is transmitted without interference or collisions. The IEEE 802.Qbv protocol, in conjunction with the CNC, offers enhanced real-time capabilities within a TSN, facilitating reliable communication for time-sensitive applications.

In accordance with the IEEE 802.Qbv scheduling protocol, the diagnostic stream producer 602 starts transmission when a start time for the schedule window 1004 opens and stops transmission when an end time for the schedule window 1004 closes. The diagnostic stream 636 traverses a network path through the TSN 102 that includes any number of intermediate TSN nodes 2 through N, where N represents any positive integer, until it finally arrives at the diagnostic stream consumer 604. When an intermediate node N receives the ACP 1002 in a receive queue within the boundaries of the schedule window 1004 assigned to the diagnostic stream producer 602, it transmits the ACP 1002 from a transmit queue in the schedule window 1004 assigned to the intermediate node. This process continues through the intermediate nodes until the ACP 1002 arrives at a receive queue for the diagnostic stream consumer 604.

A security monitor 614 uses a set of specific scheduled diagnostic windows (or time windows), along with the schedule window 1004 (e.g., a Qbv window), to analyze diagnostic traffic and determine whether the ACP 1002 experiences any time anomalies while traversing the network path. In one embodiment, the set of diagnostic windows includes a probe window 1032 and a characterization window 1006.

In one embodiment, the security monitor 614 uses a first diagnostic window referred to as a probe window 1032. The probe window 1032 is a reference window of a length that matches the ACP window 660 assigned to TSN node 1. For example, the probe window 1032 and the ACP window 660 are set to a length that matches a length of a UDP datagram carrying the ACP 1002. In one embodiment, for example, the probe window 1032 and the ACP window 660 matches a schedule window 1004 assigned by a central network controller (CNC) for the TSN 102.

In one embodiment, the security monitor 614 uses a second diagnostic window referred to as a characterization window 1006. The characterization window 1006 comprises multiple characterization window time slots (CWTS), where each CWTS is associated with one of the TSN nodes 1-N. For example, assume a case where there are 6 TSN nodes along a network path in the TSN 102 between the diagnostic stream producer 602 and the diagnostic stream consumer 604, inclusive (i.e., N=6). In this case, the characterization window 1006 includes 6 CWTS, depicted as CWTS 1008, CWTS 1010, CWTS 1012, CWTS 1014, CWTS 1016, and CWTS 1018, where each CWTS 1008-1018 corresponds to a time slot assigned to TSN nodes 1-6, respectively.

When the ACP 1002 arrives at the diagnostic stream consumer 604 (e.g., TSN node 6), the security monitor 614 examines a pattern for the probe window 1032 to determine whether the diagnostic stream consumer 604 receives the ACP 1002 within the boundaries of the probe window 1032. If the ACP 1002 aligns with the boundaries of the probe window 1032, this means that each node in the network path transmitted the ACP 1002 within its schedule window 1004 and did not buffer any portions of the ACP 1002 for transmission in another cycle. For example, the ACP 1002 aligns with the boundaries of the probe window 1032 when a leading edge and a trailing edge of the ACP 1002 fits within both boundaries of the probe window 1032. Based on this information, the security monitor 614 concludes that there is not a desynchronization event occurring for one or more of the TSN nodes along the network path traversed by the ACP 1002.

If the ACP 1002 is misaligned with the boundaries of the probe window 1032, however, this means that a node in the network path transmitted or received the ACP 1002 outside of the boundaries of the schedule window 1004. For example, the ACP 1002 is misaligned with the boundaries of the probe window 1032 when a leading edge or a trailing edge of the ACP 1002 crosses one or both boundaries of the probe window 1032. When this occurs, the security monitor 614 detects evidence of a desynchronization event occurring for one or more of the TSN nodes along the network path traversed by the ACP 1002. At this point, the security monitor 614 is aware of an ongoing desynchronization attack, but it is not able to localize which of the one or more TSN nodes along the network path traversed by the ACP 1002 is actually compromised and under the desynchronization attack.

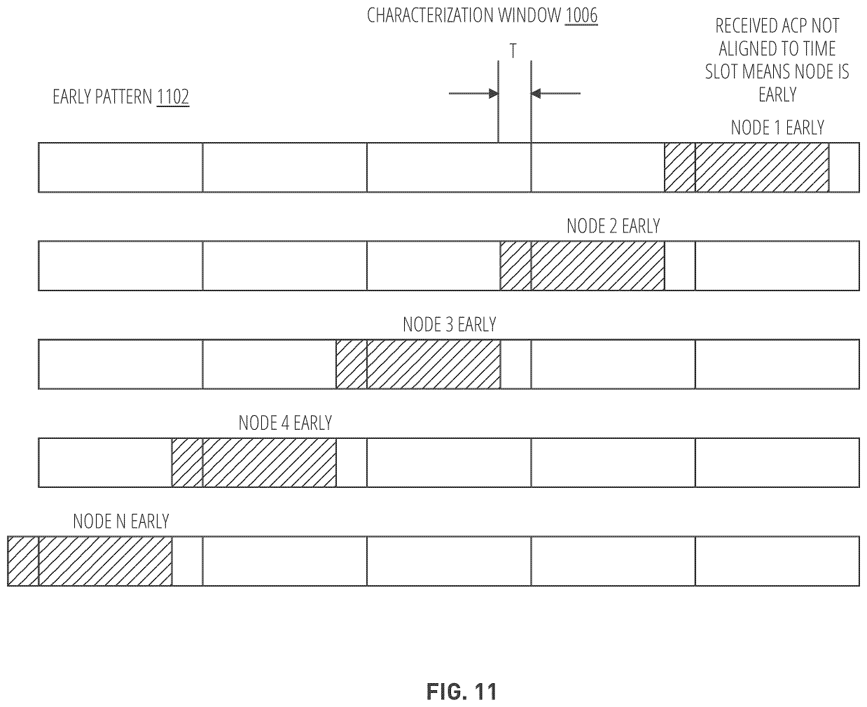

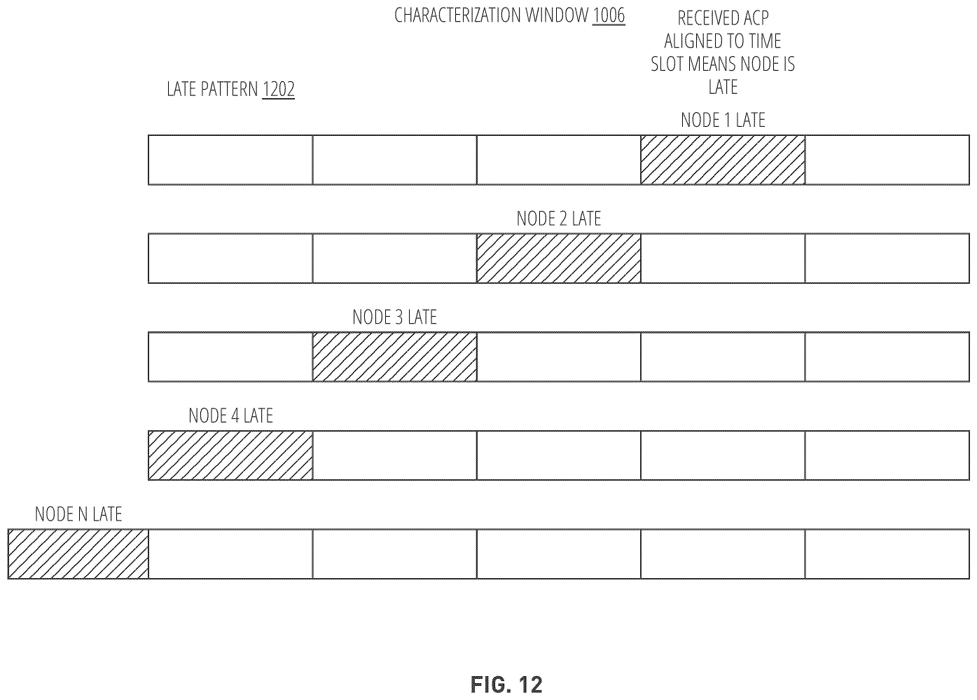

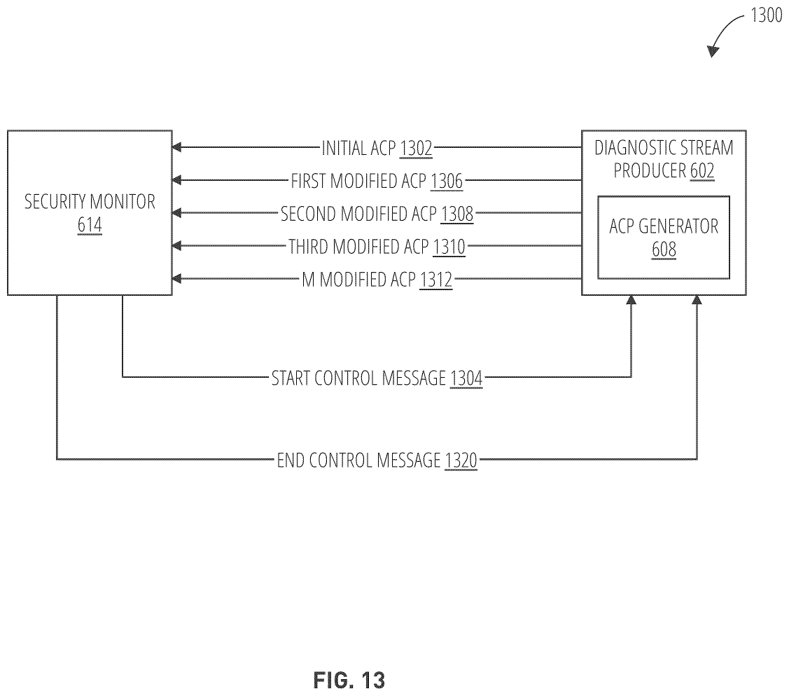

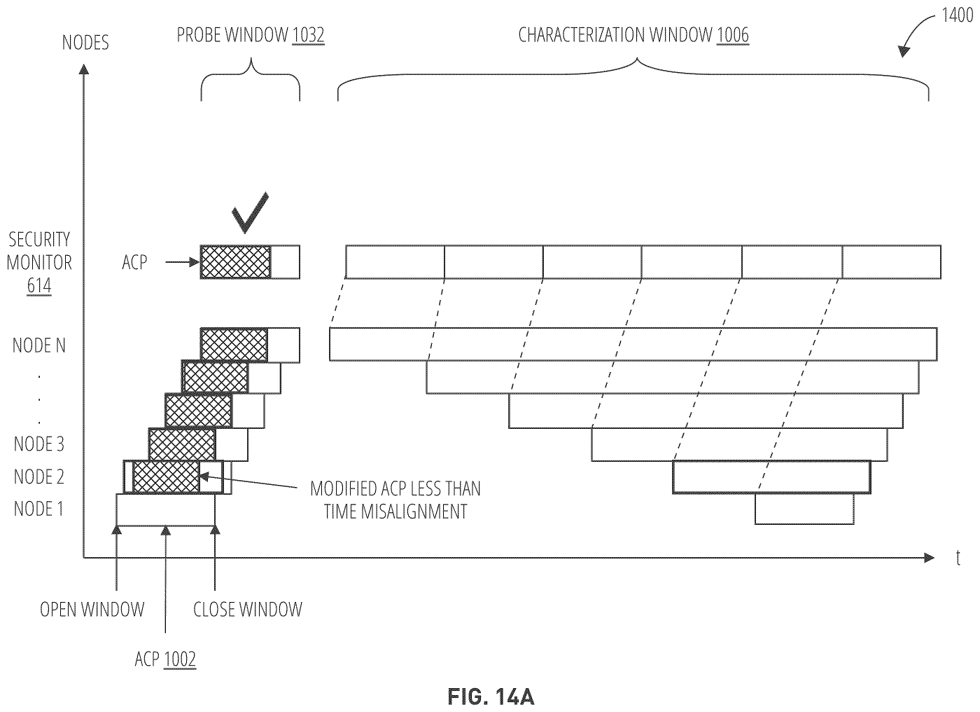

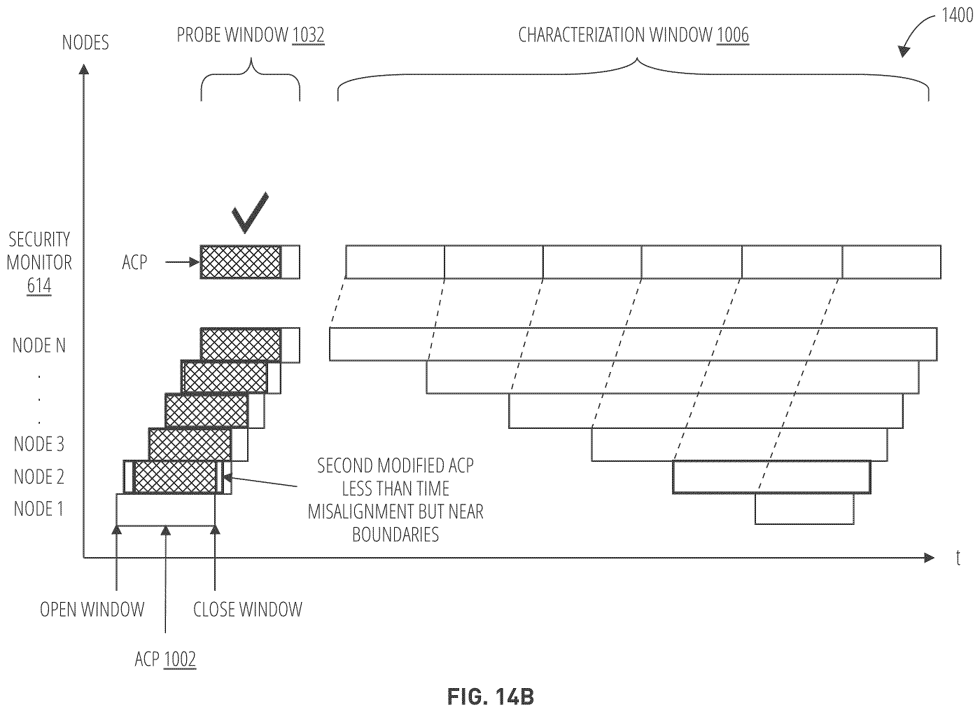

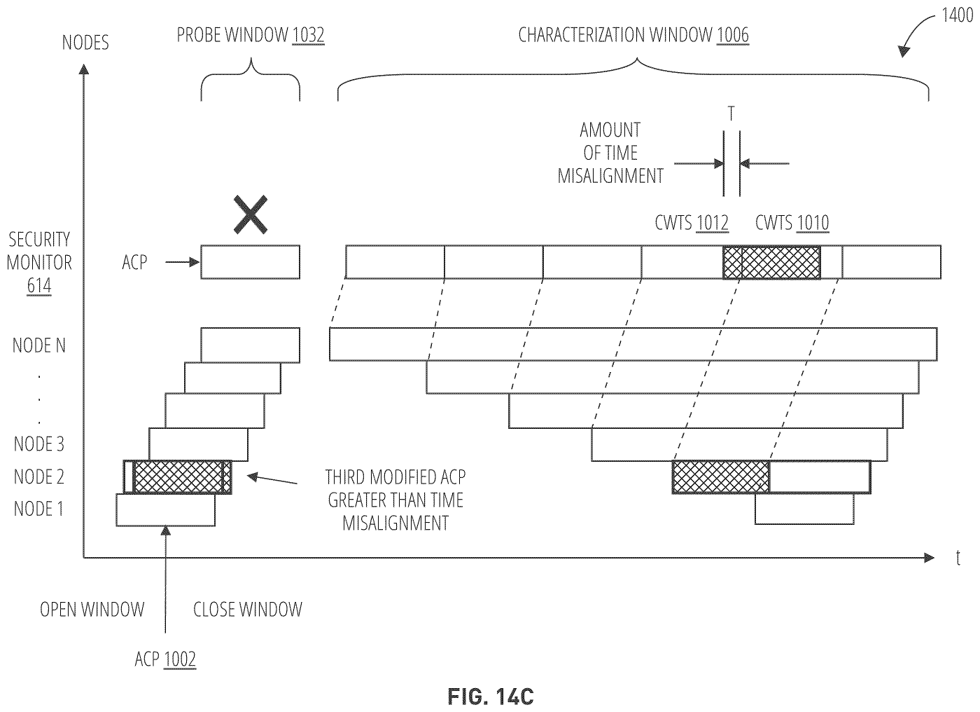

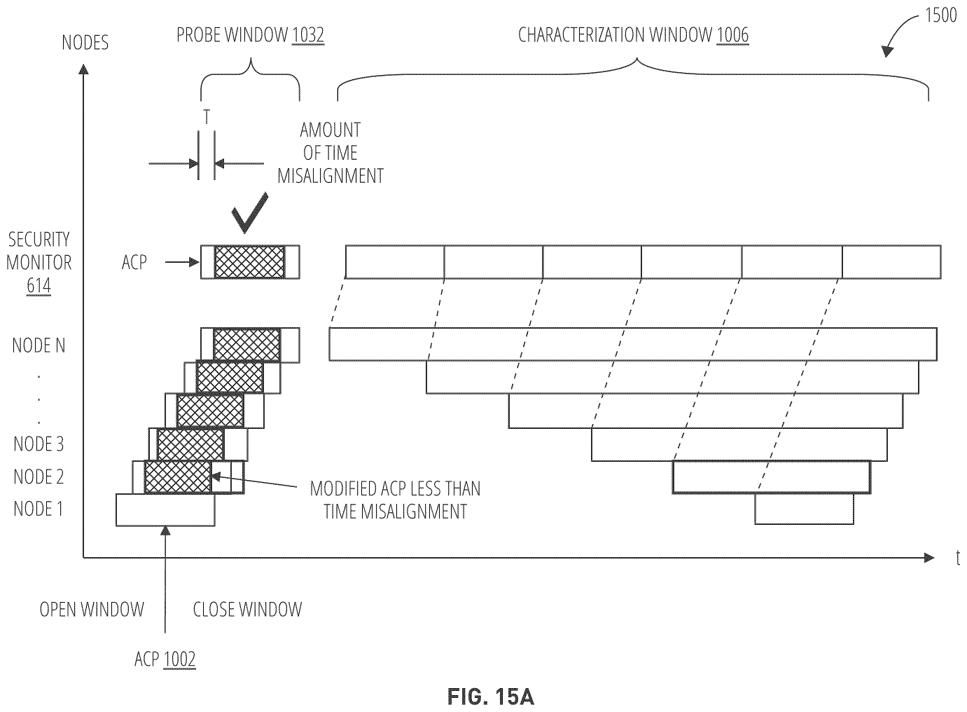

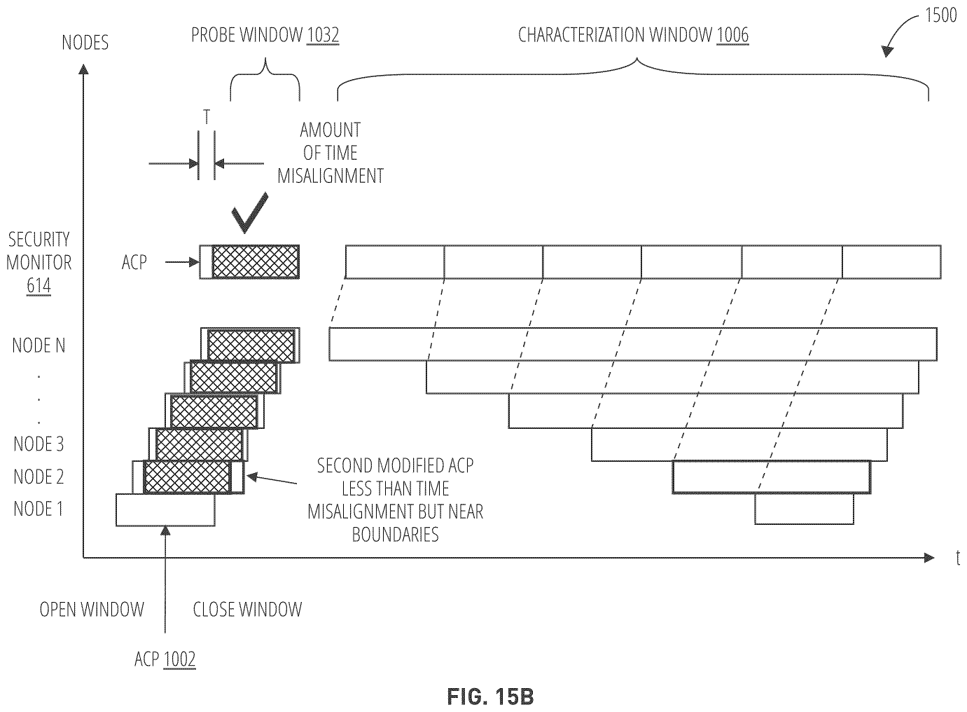

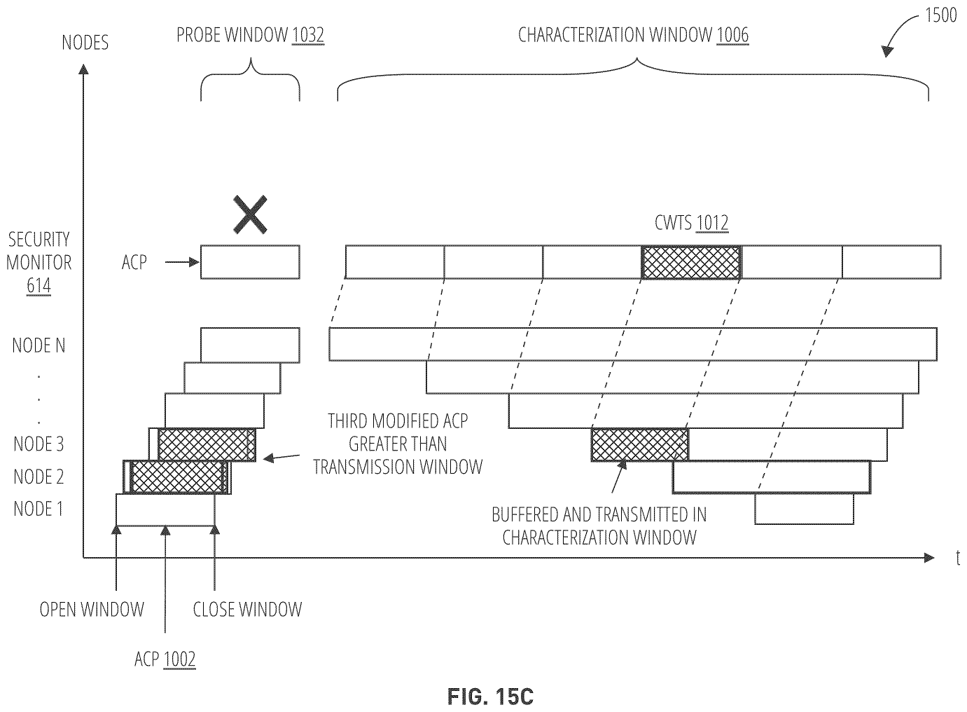

Upon detection of a time misalignment, the security monitor 614 performs two subsequent operations in no particular order. First, it proceeds to analyze the ACP 1002 in the context of the characterization window 1006 to localize which of the intermediate nodes is under attack. The security monitor 614 examines the characterization window 1006 for a pattern, such as an early pattern or a late pattern, that indicates a source for the time misalignment. A pattern matching operation is further described with reference to FIG. 10B, FIG. 10C, FIG. 11, and FIG. 12. Second, it initiates a probe operation to probe a channel along the network path between the diagnostic stream producer 602 and the diagnostic stream consumer 604 to determine a magnitude of a time misalignment from the time schedule set for the TSN 102. Upon detecting a time misalignment, the security monitor 614 sends control messages to the ACP generator 608 of the diagnostic stream producer 602 to adjust the ACP size dynamically and continuously to methodically probe the channel along the network path. If an ACP 1002 reaches the security monitor 614 according to a pattern, then the bit-width difference of the succeeding ACP 1002 indicates the amount of time misalignment of the schedule windows (e.g., Qbv windows). The second operation is further described with reference to FIG. 13, FIG. 14A, FIG. 14B, FIG. 14C, FIG. 15A, FIG. 15B, and FIG. 15C.

FIG. 10B illustrates a second example of the operating environment 1000. As with FIG. 10A, the operating environment 1000 is an example of a diagnostic stream producer 602 transmitting an ACP 1002 to a diagnostic stream consumer 604. The diagnostic stream consumer 604 receives the ACP 1002. A security monitor 614 analyzes a pattern, such as an early pattern or late pattern, for the received ACP 1002 to detect any time anomalies. Specifically, the security monitor 614 analyzes a pattern for the characterization window 1006 to determine whether a local clock of a TSN node along the network path has an earlier time bias or a later time bias caused by a desynchronization attack. In the example depicted in FIG. 10B, a local clock of a TSN node has an earlier time bias.

Similar to FIG. 10A, a TSN node 1 operates as a diagnostic stream producer 602 and it generates an ACP 1002 according to an initial size to ensure a tight fit within an ACP window 660. In one embodiment, for example, the initial size of the ACP 1002 is the length of a single UDP datagram. The diagnostic stream producer 602 transmits the ACP 1002 as part of diagnostic messages 642 of a diagnostic stream 636 to the diagnostic stream consumer 604. The diagnostic stream 636 traverses a network path through the TSN 102 that includes any number of intermediate TSN nodes 2 through N, where N represents any positive integer, until it finally arrives at the diagnostic stream consumer 604.

While FIG. 10A illustrates a case where the ACP 1002 arrives at the diagnostic stream consumer 604 within the time-width boundaries of the probe window 1032, FIG. 10B illustrates a case where the ACP 1002 arrives outside of the time-width boundaries of the probe window 1032. Specifically, either a leading edge or a trailing edge of the ACP 1002 traverses one of the boundaries of the probe window 1032.

As shown, TSN node 1 sends the ACP 1002 within the schedule window 1004. TSN node 2 receives the ACP 1002. However, assume the local clock of the TSN node 2 is compromised, and therefore it measures time with an early offset relative to the network reference clock for the TSN 102. The early offset makes the local clock open and close the schedule window 1004 earlier than normal. In this case, the ACP 1002 is not received in the schedule window 1004. Instead, ACP 1002 is buffered to be transmitted in another cycle. As the ACP 1002 traverses the remaining downstream TSN nodes of the network path through the characterization windows, the ACP 1002 arrives outside of the probe window 1032 of the security monitor 614. Therefore, the security monitor 614 detects a time misalignment, and examines the CWTS of the characterization window 1006 to detect a pattern indicating which TSN node is a source of the time misalignment.

When TSN node 2 buffered the ACP 1002, it transmitted the ACP 1002 in another cycle represented by one of the CWTS of the characterization window 1006. When the ACP 1002 arrives at the diagnostic stream consumer 604 and it is misaligned with the probe window 1032, the security monitor 614 performs a pattern matching operation that compares a reference pattern for the characterization window 1006 to an actual time slot when the ACP 1002 actually arrived at the diagnostic stream consumer 604. The security monitor 614 determines that the ACP 1002 arrived at CWTS 1010 which is a time slot that corresponds to TSN node 2. Further, the security monitor 614 determines that the leading edge of the ACP 1002 arrived early since it partially overlaps a boundary for the CWTS 1012 which corresponds to TSN node 3. Based on this information, the security monitor 614 concludes that TSN node 2 is under a desynchronization attack with an earlier time offset. The security monitor 614 reaches this conclusion because the security monitor 614 has a rule that indicates that any time the ACP 1002 is outside of the time-width boundaries of one of the CWTS of the characterization window 1006 corresponding to a given node N, the node under attack is actually the node N. Further, based on this information, the security monitor 614 concludes that TSN node 2 is under a desynchronization attack with an earlier time offset having an amount of early time misalignment of approximately T.

FIG. 10C illustrates a third example of the operating environment 1000. As with FIG. 10A and FIG. 10B, the operating environment 1000 is an example of a diagnostic stream producer 602 transmitting an ACP 1002 to a diagnostic stream consumer 604. The diagnostic stream consumer 604 receives the ACP 1002. A security monitor 614 analyzes a pattern for the received ACP 1002 to detect any time anomalies. Specifically, the security monitor 614 analyzes a pattern for the characterization window 1006 to determine whether a local clock of a TSN node along the network path has an earlier time bias or a later time bias caused by a desynchronization attack. In the example depicted in FIG. 10C, a local clock of a TSN node has a later time bias.

Similar to FIG. 10A and FIG. 10B, a TSN node 1 operates as a diagnostic stream producer 602 and it generates an ACP 1002 according to an initial size to ensure a tight fit within an ACP window 660. In one embodiment, for example, the initial size of the ACP 1002 is the length of a single UDP datagram. The diagnostic stream producer 602 transmits the ACP 1002 as part of diagnostic messages 642 of a diagnostic stream 636 to the diagnostic stream consumer 604. The diagnostic stream 636 traverses a network path through the TSN 102 that includes any number of intermediate TSN nodes 2 through N, where N represents any positive integer, until it finally arrives at the diagnostic stream consumer 604.

While FIG. 10A illustrates a case where the ACP 1002 arrives at the diagnostic stream consumer 604 within the time-width boundaries of the probe window 1032, FIG. 10C illustrates a case where the ACP 1002 arrives outside of the time-width boundaries of the probe window 1032.

As shown, TSN node 1 sends the ACP 1002 within the schedule window 1004 on time. TSN node 2 receives the ACP 1002. However, assume the local clock of the TSN node 2 is compromised, and therefore it measures time with a late offset relative to the network reference clock for the TSN 102. The late offset makes the local clock open and close the schedule window 1004 later than normal. In other words, TSN node 2 receives the ACP 1002 “early” according to its own reference of time and buffers it to transmit when its TX window opens. In this case, the ACP 1002 is not received in the schedule window 1004. Instead, ACP 1002 is buffered to be transmitted in another cycle. As the ACP 1002 traverses the remaining downstream TSN nodes of the network path, the ACP 1002 arrives outside of the probe window 1032 of the security monitor 614. Therefore, the security monitor 614 detects a time misalignment, and examines the characterization window 1006 to detect a pattern indicating which node is a source of the time misalignment.

Since TSN node 2 is late in reference to TSN node 3, the propagation of the ACP 1002 along a link between TSN node 2 and TSN node 3 causes link delay, and through the TSN node 3 causes node delay, thereby causing the ACP 1002 to not arrive fully within the schedule window 1004 of the TSN node 3 to be transmitted in time. A tail of the ACP 1002 falls off of the TX window of the TSN node 3 and is buffered. When TSN node 3 buffered the ACP 1002, it transmitted the ACP 1002 in the next opportunity, which is one of the CWTS of the characterization window 1006.

When the ACP 1002 arrives at the diagnostic stream consumer 604, the security monitor 614 determines the ACP 1002 did not arrive in window 1032. It then performs a pattern matching operation that compares a reference pattern for the characterization window 1006 to an actual time slot when the ACP 1002 actually arrived at the diagnostic stream consumer 604. The security monitor 614 determines that the ACP 1002 arrived at CWTS 1012 which corresponds to TSN node 3. Further, the security monitor 614 determines that the ACP 1002 aligns with (e.g., fits within) the time-width boundaries for the CWTS 1012 which corresponds to TSN node 3. Based on this information, the security monitor 614 concludes that TSN node 2 is under a desynchronization attack with a later time offset. This is because the security monitor 614 has a rule that indicates that any time the ACP 1002 fits within the time-width boundaries of one of the CWTS of the characterization window 1006 corresponding to a given node N, the node under attack is actually the preceding node N−1. In this case, since the ACP 1002 aligns with the CWTS 1012, which is associated with the TSN node 3, the security monitor 614 concludes that the source of the time misalignment is TSN node 2.

The security monitor 614 is able to localize a source for a later time misalignment based on the pattern for the characterization window 1006. However, the security monitor 614 cannot determine an amount of later time misalignment introduced by the TSN node 2. It therefore initiates a probe operation to determine the amount of time misalignment introduced by the TSN node 2.

FIG. 11 illustrates an example of an early pattern 1102 used for the pattern matching operations of the security monitor 614. Specifically, the security monitor 614 uses the early pattern 1102 to detect, localize, and quantify which of the intermediate nodes N are early in time.

As previously discussed, when a received ACP 1002 is not aligned to a CW time slot of the characterization window 1006, such as when the ACP 1002 does not entirely fit within the time-width boundaries of the CW time slot, the security monitor 614 concludes that the TSN node N corresponding to the CW time slot is under a desynchronization attack to cause the local clock of the TSN node N to have an earlier time offset relative to the network clock of the TSN 102.

As depicted in FIG. 11, the early pattern 1102 illustrates cases where the ACP 1002 arrives earlier for the TSN node 1 through TSN node N, where each case has the ACP 1002 for a CWTS for a TSN node N overlapping a boundary for a succeeding TSN node N+1, thereby indicating the TSN node Nis under an earlier time attack. For example, assume TSN node 2 is early in time. The early pattern 1102 would indicate that the ACP 1002 arrives in a CWTS corresponding to TSN node 2, with an edge crossing a time boundary of the CWTS corresponding to TSN node 3. Based on this information, the security monitor 614 detects an early time misalignment, localizes TSN node 2 as under an early time attack, and quantifies a magnitude of the early attack based on the overlap time T.

Even though the security monitor 614 may roughly approximate the magnitude of an early attack, the security monitor 614 may be set to obtain a finer-grained approximation for the magnitude of the early attack. In this case, the security monitor 614 may initiate probe operations as described with reference to FIG. 13.

FIG. 12 illustrates an example of a late pattern 1202 used for the pattern matching operations of the security monitor 614. Specifically, the security monitor 614 uses the late pattern 1202 to detect and localize which of the intermediate nodes N are late in time. Unlike the early pattern 1102, however, the late pattern 1202 does not provide any quantification of an amount of time misalignment.

As previously discussed, when a received ACP 1002 is fully aligned to a CW time slot of the characterization window 1006, that is when the ACP 1002 does fit entirely within the time-width boundaries of the CW time slot, the security monitor 614 concludes that the TSN node preceding the TSN node N corresponding to the CW time slot is under a desynchronization attack to cause the local clock of the TSN node N to have a later time offset relative to the network clock of the TSN 102.

As depicted in FIG. 12, the late pattern 1202 illustrates cases where the ACP 1002 arrives later for the TSN node 1 through TSN node N, where each case has the ACP 1002 for a CW time slot for a TSN node N fitting entirely within boundaries for the TSN node N, thereby indicating the preceding TSN node N−1 is under a later time attack. For example, assume TSN node 2 is late in time. The late pattern 1202 would indicate that the ACP 1002 arrives in a CWTS corresponding to TSN node 3, with the ACP 1002 fitting entirely within the time-width boundaries of the CWTS corresponding to TSN node 3. Based on this information, the security monitor 614 detects a late time misalignment, localizes TSN node 2 as under a late time attack. However, the security monitor 614 is unable to quantify a magnitude of the late attack at TSN node 2. Therefore, the security monitor 614 initiates probe operations to quantify a magnitude of the late attack at TSN node 2, as described with reference to FIG. 13.

As depicted in the early pattern 1102 of FIG. 11 and the late pattern 1202 of FIG. 12, a single CW time slot assigned to a TSN node N may indicate whether a preceding TSN node N−1 is late or the TSN node N is early. For example, a single CW time slot assigned to TSN node 2 may indicate whether the TSN node 1 is late or the TSN node 2 is early, where the former case is identified when the ACP 1002 fits entirely within the CWTS assigned to TSN node 2, and where the latter case is identified when the ACP 1002 does not fit entirely within the CWTS assigned to TSN node 2.

FIG. 13 illustrates an operating environment 1300. The operating environment 1300 is an example of the security monitor 614 performing probe operations to determine a magnitude of a time misalignment. For example, the security monitor 614 may initiate probe operations to determine a finer approximation for a magnitude of an early time misalignment T, or it may determine an approximation of a magnitude of a late time misalignment.

As depicted in FIG. 13, the security monitor 614 initiates probe operations which involves a dynamic resizing of an initial ACP 1302, which is an example for the ACP 1002. Prior to detecting a time misalignment, the diagnostic stream producer 602 sends an initial ACP 1302 as part of a diagnostic stream 636. The ACP generator 608 of the diagnostic stream producer 602 generates the initial ACP 1302 with an initial default size that tightly fits within the ACP window 660 and the probe window 1032.

Assume the security monitor 614 of a diagnostic stream consumer 604 receives the initial ACP 1302 from the diagnostic stream producer 602. Upon detection of a time misalignment at the security monitor 614 using the probe window 1032 and the characterization window 1006, the security monitor 614 initiates a probe sequence to determine a modification to a size for the initial ACP 1302 that would go through a probe channel between the diagnostic stream producer 602 and diagnostic stream consumer 604 without being delayed.

The security monitor 614 sends a start control message 1304 to the diagnostic stream producer 602 to start probe operations. The diagnostic stream producer 602 instructs the ACP generator 608 to reduce a size for the initial ACP 1302 to form a first modified ACP 1306. For example, the ACP generator 608 may perform bit-level adjustments for the first modified ACP 1306 by decreasing a padding value for the paddings 706. The diagnostic stream producer 602 sends the first modified ACP 1306 to the diagnostic stream consumer 604 through the diagnostic stream 636. The security monitor 614 receives the first modified ACP 1306, and it examines whether the first modified ACP 1306 fits within the probe window 1032.

If the first modified ACP 1306 fits within the probe window 1032, the ACP generator 608 increases a size of the first modified ACP 1306 to form a second modified ACP 1308. For example, bit-level adjustments may be made in the first modified ACP 1306 by increasing a padding value for the paddings 706. The diagnostic stream producer 602 sends the second modified ACP 1308 to the diagnostic stream consumer 604. The security monitor 614 receives the second modified ACP 1308, and it examines whether the second modified ACP 1308 fits within the probe window 1032.

If the first modified ACP 1306 is outside of the probe window 1032, the ACP generator 608 again decreases a size of the first modified ACP 1306 to form the second modified ACP 1308, and restarts the probe process.

If the second modified ACP 1308 fits within the probe window 1032, the ACP generator 608 increases a size of the second modified ACP 1308 to form a third modified ACP 1310. For example, bit-level adjustments may be made in the second modified ACP 1308 by increasing a padding value for the paddings 706. The diagnostic stream producer 602 sends the third modified ACP 1310 to the diagnostic stream consumer 604. The security monitor 614 receives the third modified ACP 1310, and it examines whether the third modified ACP 1310 fits within the probe window 1032.

The probe process continues for multiple iterations or trials M with M modified ACP 1312, where M represents any positive integer, until the M modified ACP 1312 is outside of the boundaries of the probe window 1032. The security monitor 614 then analyzes the characterization window 1006 to determine an amplitude or magnitude for the time misalignment, using a pattern matching algorithm similar to the early pattern 1102, to determine an amplitude or magnitude of a time misalignment T. The security monitor 614 then sends an end control message 1320 to the diagnostic stream producer 602 to terminate probe operations.

The ACP generator 608 may increase or decrease the size of the ACPs by increasing or decreasing a padding value for the paddings 706. For example, the padding adjustment engine 712 and/or the padding generator 714 may adjust or generate more or less P bits for the padding 706. This can be done using a search algorithm, such as a sequential (decrescent) search algorithm, binary search algorithm, or some other suitable search algorithm designed to efficiently perform searches while reducing or minimizing a number of iterations or trials for the probe operations.

FIG. 14A illustrates an operating environment 1400. The operating environment 1400 is a first example of probe operations as described with reference to FIG. 13 with 3 iterations or trials of probe operations (i.e., M=3). Specifically, the operating environment 1400 illustrates a first example of probe operations for the security monitor 614 to determine an amount of early time misalignment of a TSN node.

In trial 1, a first modified ACP 1306 traverses the network path to the security monitor 614. A size for the first modified ACP 1306 is less than the initial ACP 1302 and the time misalignment. The security monitor 614 examines the probe window 1032 and it determines that the first modified ACP 1306 fits within the boundaries of the probe window 1032.

FIG. 14B illustrates an operating environment 1400. The operating environment 1400 is a second example of probe operations as described with reference to FIG. 13 with 3 iterations or trials of probe operations (i.e., M=3). Specifically, the operating environment 1400 illustrates a second example of probe operations for the security monitor 614 to determine an amount of early time misalignment of a TSN node.

After completing trial 1, in trial 2, a second modified ACP 1308 traverses the network path to the security monitor 614. A size for the second modified ACP 1308 is greater than the first modified ACP 1306 and less than the time misalignment. The security monitor 614 examines the probe window 1032 and it determines that the second modified ACP 1308 also fits within the boundaries of the probe window 1032. However, the edges of the second modified ACP 1308 are closer to the boundaries of the probe window 1032 relative to the first modified ACP 1306.

FIG. 14C illustrates an operating environment 1400. The operating environment 1400 is a third example of probe operations as described with reference to FIG. 13 with 3 iterations or trials of probe operations (i.e., M=3). Specifically, the operating environment 1400 illustrates a third example of probe operations for the security monitor 614 to determine an amount of early time misalignment of a TSN node.

After completing trial 2, in trial 3, a third modified ACP 1310 traverses the network path to the security monitor 614. A size for the third modified ACP 1310 is greater than the second modified ACP 1308 and also the time misalignment. The security monitor 614 examines the probe window 1032 and it determines that the third modified ACP 1310 is outside of the boundaries of the probe window 1032. The security monitor 614 then examines the characterization window 1006 and it determines the third modified ACP 1310 was received in CWTS 1012 assigned to TSN node 2 with a portion of the third modified ACP 1310 overlapping a boundary for CWTS 1014 assigned to TSN node 3. At this point, the security monitor 614 measures an amount of overlap to determine an amount of early time misalignment of T.

FIG. 15A illustrates an operating environment 1500. The operating environment 1500 is a first example of probe operations as described with reference to FIG. 13 with 3 iterations or trials of probe operations (i.e., M=3). Specifically, the operating environment 1500 illustrates a first example of probe operations for the security monitor 614 to determine an amount of late time misalignment of a TSN node.

In trial 1, a first modified ACP 1306 traverses the network path to the security monitor 614. A size for the first modified ACP 1306 is less than the initial ACP 1302 and the time misalignment. The security monitor 614 examines the probe window 1032 and it determines that the first modified ACP 1306 fits within the boundaries of the probe window 1032. The security monitor 614 can quantify an amount of time misalignment T using the probe window 1032. For example, the amount of time misalignment T in relation to the beginning of the probe window 1032 approximates the delay of TSN node 2.

FIG. 15B illustrates an operating environment 1500. The operating environment 1500 is a second example of probe operations as described with reference to FIG. 13 with 3 iterations or trials of probe operations (i.e., M=3). Specifically, the operating environment 1500 illustrates a second example of probe operations for the security monitor 614 to determine an amount of late time misalignment of a TSN node.

After completing trial 1, in trial 2, a second modified ACP 1308 traverses the network path to the security monitor 614. A size for the second modified ACP 1308 is greater than the first modified ACP 1306 and less than the time misalignment. The security monitor 614 examines the probe window 1032 and it determines that the second modified ACP 1308 also fits within the boundaries of the probe window 1032. However, the second modified ACP 1308 is closer to the boundaries of the probe window 1032 relative to the first modified ACP 1306. The security monitor 614 can quantify an amount of time misalignment T using the probe window 1032. For example, the amount of time misalignment T in relation to the beginning of the probe window 1032 approximates the delay of TSN node 2. Note that the amount of time misalignment T of trial 2 is less than the amount of time misalignment T of trial 1 due in part to the larger size of the second modified ACP 1308 relative to the first modified ACP 1306.

FIG. 15C illustrates an operating environment 1500. The operating environment 1500 is a third example of probe operations as described with reference to FIG. 13 with 3 iterations or trials of probe operations (i.e., M=3). Specifically, the operating environment 1500 illustrates a third example of probe operations for the security monitor 614 to determine an amount of late time misalignment of a TSN node.

After completing trial 2, in trial 3, a third modified ACP 1310 traverses the network path to the security monitor 614. A size for the third modified ACP 1310 is greater than the second modified ACP 1308 and also the time misalignment. The security monitor 614 examines the probe window 1032 and it determines that the third modified ACP 1310 is outside of the boundaries of the probe window 1032. The security monitor 614 then examines the characterization window 1006 and it determines the third modified ACP 1310 was received in CWTS 1012 assigned to TSN node 3. At this point, since the second modified ACP 1308 was the largest acceptable size that would fit within the probe window 1032, the security monitor 614 uses the amount of time misalignment T calculated using the second modified ACP 1308 during trial 2 to quantify the amount of late time misalignment of the TSN node 2. In this way, the multiple trials for the probe operations allow for a determination of a fine-grained measurement of time misalignment based on the last size of an ACP that entirely fits within the probe window 1032.

As described herein, the security monitor 614 may use different strategies for implementing probe operations. For example, transmitter nodes can perform these measurements open-loop, where they cycle through default and measurements of ACPs 612. In this case, the security monitor 614 would receive ACPs 612 and determine misalignments when anomalies occur. In this case, a pre-programmed algorithm can be used for a probe operation to vary the size of ACPs in different interactions. The monitor would be able to analyze the received ACPs to determine which ACP is successfully going through the channel and which ACP is not (e.g., being buffered) using the diagnostic windows. Another example is use of a closed-loop between security monitor 614 and transmitter nodes. In this case, the transmitter node would keep sending default ACPs 612, until the security monitor 614 detects anomalies and requests ACPs 612 of different sizes to perform measurements.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not have to be executed in the order presented unless otherwise indicated. Moreover, some acts illustrated in a logic flow may be performed in some embodiments. In addition, the given logic flow may be implemented by a hardware element, a software element executed by a processor, or any combination thereof. The embodiments are not limited in this context.

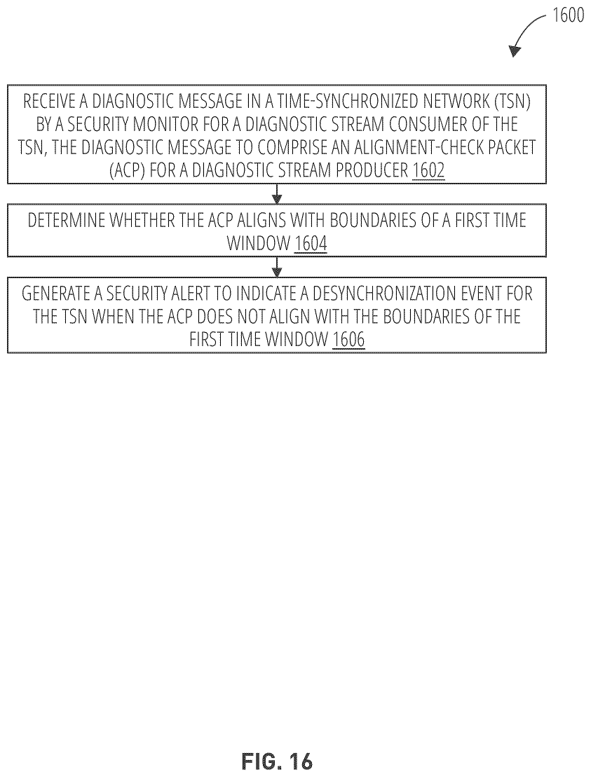

FIG. 16 illustrates an embodiment of a logic flow 1600. The logic flow 1600 may be representative of some operations executed by one or more embodiments described herein. For example, the logic flow 1600 may include some operations performed by devices or entities within the TSNs 102, 200 or 300, the TSN node 104, the IDS 110, the apparatus 400, the apparatus 500, and/or the system 600. More particularly, the logic flow 1600 illustrates an example where a diagnostic stream consumer 604 receives a diagnostic stream 636 or a unified stream 638 transporting diagnostic information for one or more TSN nodes 104, and analyzes the diagnostic information to determine whether the one or more TSN nodes 104 are under a security attack based on the analysis.

In block 1602, logic flow 1600 receives a diagnostic message in a time-synchronized network (TSN) by a security monitor for a diagnostic stream consumer of the TSN, the diagnostic message to comprise an alignment check packet (ACP) for a diagnostic stream producer. In block 1604, logic flow 1600 determines whether the ACP aligns with boundaries of a first time window. In block 1606, logic flow 1600 generates a security alert to indicate a desynchronization event for the TSN when the ACP is misaligned with the boundaries of the first time window.

By way of example, the security monitor 614 may receive a diagnostic message 916 in a TSN 102 for a diagnostic stream consumer 604 of the TSN 102. The diagnostic message 916 may comprise an ACP 1002 for a diagnostic stream producer 602. The security monitor 614 determines whether the ACP 1002 aligns with boundaries of a first time window. An example of a first time window is a probe window 1032. The security monitor 614 generates a security alert to indicate a desynchronization event for the TSN 102 when the ACP 1002 is misaligned with the boundaries of the first time window. The security monitor 614 concludes that there is no desynchronization event for the TSN 102 when the ACP 1002 does align with the boundaries of the first time window.

In one embodiment, the security monitor 614 determines the ACP 1002 is received in a time slot of a second time window when the ACP 1002 is misaligned with the boundaries of the first time window. An example of a time slot of a second time window is a CW time slot of the characterization window 1006. The security monitor 614 identifies a TSN node N as a source of the desynchronization event based on the time slot of the second time window.

In one embodiment, the security monitor 614 identifies the TSN node N associated with the time slot as the source of the desynchronization event when the ACP 1002 is misaligned with boundaries of the time slot. For example, the security monitor 614 may use the operating environment 1000 of FIG. 10B and the early pattern 1102 as a reference for the characterization window 1006.

In one embodiment, the security monitor 614 identifies the TSN node N associated with a time slot preceding the time slot as the source of the of the desynchronization event when the ACP 1002 does align with boundaries of the time slot. For example, the security monitor 614 may use the operating environment 1000 of FIG. 10C and the late pattern 1202 as a reference for the characterization window 1006.

In one embodiment, the security monitor 614 determines a desynchronization time T for the desynchronization event using a probe operation and the first time window or the second time window. For example, the security monitor 614 may perform the probe operation in accordance with the operating environment 1300, the operating environment 1400, and/or the operating environment 1500.

In one embodiment, the security monitor 614 receives a second diagnostic message in the TSN 102 for the diagnostic stream consumer 604 of the TSN 102. The second diagnostic message may comprise a modified ACP for the diagnostic stream producer 602. An example of a modified ACP is first modified ACP 1306, second modified ACP 1308, and/or third modified ACP 1310 as described with reference to the operating environment 1300. The modified ACP may have a length that is less than a length of the initial ACP 1302. The security monitor 614 determines the modified ACP fits within a set of boundaries of the first time window, and it determines a time difference T between one edge of the modified ACP and a boundary of the first time window as a desynchronization time for the desynchronization event. For example, the security monitor 614 may operate in accordance with the example given for the operating environment 1500.

In one embodiment, the security monitor 614 receives a second diagnostic message in the TSN 102 for the diagnostic stream consumer 604 of the TSN 102. The second diagnostic message may comprise a modified ACP for the diagnostic stream producer 602. An example of a modified ACP is first modified ACP 1306, second modified ACP 1308, and/or third modified ACP 1310 as described with reference to the operating environment 1300. The modified ACP may have a length that is less than a length of the initial ACP 1302. The security monitor 614 determines the modified ACP is outside of a set of boundaries of the first time window, and it determines a time difference T between one edge of the modified ACP and a boundary of a time slot of the second time window as a desynchronization time for the desynchronization event. For example, the security monitor 614 may operate in accordance with the example given for the operating environment 1400.

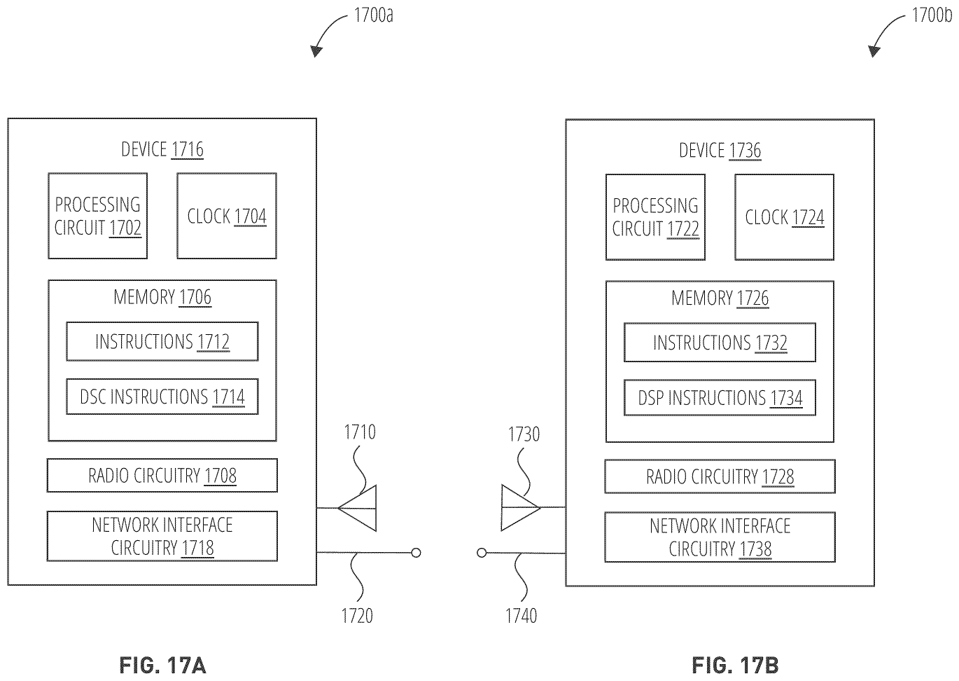

FIG. 17A depicts a device 1716. The device 1716 could be any one of the TSN nodes 104 in a TSN network. Device 1716 includes a processing circuit 1702, a clock 1704, memory 1706, radio circuitry 1708, an antenna 1710, a network interface circuitry 1718, and a wired connection 1720. Memory 1706 stores instructions 1712 and diagnostic stream consumer instructions 1714. During operation, processing circuit 1702 can execute instructions 1712 and/or diagnostic stream consumer instructions 1714 to cause device 1716 to consume, analyze and monitor diagnostic streams 636 and/or unified streams 638 carrying diagnostic messages 642 with a set of ACPs 612 from other devices in the TSN network. In some examples, processing circuit 1702 can execute instructions 1712 and/or diagnostic stream consumer instructions 1714 to cause device 1716 to operate as a clock leader (CL) for the TSN network, such as sending time synchronization messages, time update messages, and other timing messages defined by various IEEE standards as discussed herein. Furthermore, processing circuit 1702 can execute instructions 1712 to cause device 1716 to send, via radio circuitry 1708 and antenna 1710 or network interface circuitry 1718 timing messages as the CL for a CF in a TSN network. In addition, processing circuit 1702 can execute instructions 1712 to cause device 1716 to send, via radio circuitry 1708 and antenna 1710 or network interface circuitry 1718 security messages in response to a security attack, such as alert messages, notification messages, network reconfiguration messages, device isolation messages, model update messages, and other messages in a TSN network.

FIG. 17B depicts a device 1736. The device 1736 could be any one of the TSN nodes 104 in a TSN network. Device 1736 includes a processing circuit 1722, a clock 1724, memory 1726, radio circuitry 1728, an antenna 1730, a network interface circuitry 1738, and a wired connection 1740. Memory 1726 stores instructions 1732 and diagnostic stream producer instructions 1734. During operation, processing circuit 1722 can execute instructions 1732 and/or diagnostic stream producer instructions 1734 to cause device 1736 to generate and send diagnostic streams 636 and/or unified streams 638 carrying diagnostic messages 642 with a set of ACPs 612 to other devices in the TSN network. In some examples, processing circuit 1722 can execute instructions 1732 and/or diagnostic stream producer instructions 1734 to operate as a clock follower (CF) for the TSN network, such as receiving timing messages as a clock follower (e.g., from time measurements from a global clock for a TSN network) from other devices in the TSN network, such as the device 1716. In some examples, processing circuit 1722 can execute instructions 1732 and/or diagnostic stream producer instructions 1734 to cause device 1736 to receive time synchronization messages, time update messages, and other timing messages defined by various IEEE standards as discussed herein. Furthermore, processing circuit 1722 can execute instructions 1732 and/or diagnostic stream producer instructions 1734 to cause device 1736 to receive, via radio circuitry 1728 and antenna 1730 or network interface circuitry 1738 timing messages as the CF for a CL in a TSN network. In addition, processing circuit 1722 can execute instructions 1732 and/or diagnostic stream producer instructions 1734 to cause device 1736 to send, via radio circuitry 1728 and antenna 1730 or network interface circuitry 1738 security messages in response to a security attack, such as alert messages, notification messages, network reconfiguration messages, device isolation messages, model update messages, and other messages in a TSN network.

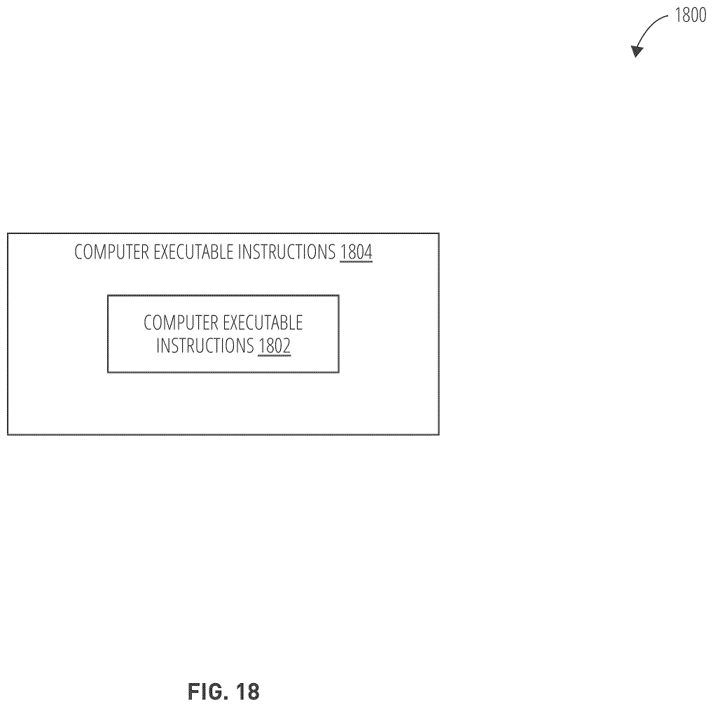

FIG. 18 illustrates computer-readable storage computer-readable medium 1800. Computer-readable storage computer-readable medium 1800 may comprise any non-transitory computer-readable storage medium or machine-readable storage medium, such as an optical, magnetic or semiconductor storage medium. In various embodiments, computer-readable storage computer-readable medium 1800 may comprise an article of manufacture. In some embodiments, computer-readable storage computer-readable medium 1800 may store computer executable instructions 1802 with which circuitry (e.g., processing circuitry 414, processor circuitry 622, processor circuitry 628, processing circuit 1702, processing circuit 1722, radio circuitry 1708, radio circuitry 1728, network interface circuitry 1718, network interface circuitry 1738, clock manager 106, clock circuitry 412, interface 626, interface 632, or the like) can execute. For example, computer executable instructions 1802 can include instructions to implement operations described with respect to logic flows 1900 and 2000. Examples of computer-readable storage computer-readable medium 1800 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1802 may include any suitable type of code, such as source code, compiled code, interpreted code, executable code, static code, dynamic code, object-oriented code, visual code, and the like.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at a part of the software or firmware application. As yet another example, a component is an apparatus that provides specific functionality through electronic components without mechanical parts; the electronic components include one or more processors therein to execute software and/or firmware that confer(s) the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims are generally construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, is partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in one embodiment. The appearances of the phrase “in one embodiment” in various places in the specification are not referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It is noted, however, that these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is desirable in many cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the purpose or it comprises a general purpose computer as selectively activated or reconfigured by a computer program stored in the computer. The procedures presented herein are not related to a particular computer or other apparatus. Various general purpose machines are used with programs written in accordance with the teachings herein, or it proves convenient to construct more specialized apparatus to perform the method steps. The structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following aspects and examples pertain to further embodiments, from which numerous permutations and configurations will be apparent.

Example 1. A method, comprising: receiving a diagnostic message in a time-synchronized network (TSN) by a security monitor for a diagnostic stream consumer of the TSN, the diagnostic message to comprise an alignment check packet (ACP) for a diagnostic stream producer; determining whether the ACP aligns with boundaries of a first time window; and generating a security alert to indicate a desynchronization event for the TSN when the ACP is misaligned with the boundaries of the first time window.

Example 2. Further to any previous example, comprising: determining the ACP is received in a time slot of a second time window when the ACP is misaligned with the boundaries of the first time window; and identifying a TSN node as a source of the desynchronization event based on the time slot of the second time window.

Example 3. Further to any previous example, comprising identifying the TSN node associated with the time slot as the source of the desynchronization event when the ACP is misaligned with boundaries of the time slot.

Example 4. Further to any previous example, comprising identifying the TSN node associated with a time slot preceding the time slot as the source of the of the desynchronization event when the ACP does align with boundaries of the time slot.

Example 5. Further to any previous example, comprising determining a desynchronization time for the desynchronization event using a probe operation and the first time window or the second time window.

Example 6. Further to any previous example, comprising: receiving a second diagnostic message in the TSN by the security monitor for the diagnostic stream consumer of the TSN, the second diagnostic message to comprise a modified ACP for the diagnostic stream producer, the modified ACP having a length that is less than a length of the ACP; determining the modified ACP fits within a set of boundaries of the first time window; and determining a time difference between one edge of the modified ACP and a boundary of the first time window as a desynchronization time for the desynchronization event.

Example 7. Further to any previous example, comprising: receiving a second diagnostic message in the TSN by the security monitor for the diagnostic stream consumer of the TSN, the second diagnostic message to comprise a modified ACP for the diagnostic stream producer, the modified ACP having a length that is less than a length of the ACP; determining the modified ACP is outside of a set of boundaries of the first time window; and determining a time difference between one edge of the modified ACP and a boundary of a time slot of the second time window as a desynchronization time for the desynchronization event.

Example 8. A non-transitory computer-readable storage medium, the computer-readable storage medium including instructions that when executed by processing circuitry, cause the processing circuitry to: receive a diagnostic message in a time-synchronized network (TSN) by a security monitor for a diagnostic stream consumer of the TSN, the diagnostic message to comprise an alignment check packet (ACP) for a diagnostic stream producer; determine whether the ACP aligns with boundaries of a first time window; and generate a security alert to indicate a desynchronization event for the TSN when the ACP is misaligned with the boundaries of the first time window.

Example 9. Further to any previous example, comprising instructions that when executed by processing circuitry, cause the processing circuitry to: determine the ACP is received in a time slot of a second time window when the ACP is misaligned with the boundaries of the first time window; and identify a TSN node as a source of the desynchronization event based on the time slot of the second time window.

Example 10. Further to any previous example, comprising instructions that when executed by processing circuitry, cause the processing circuitry to identify the TSN node associated with the time slot as the source of the desynchronization event when the ACP is misaligned with boundaries of the time slot.

Example 11. Further to any previous example, comprising instructions that when executed by processing circuitry, cause the processing circuitry to identify the TSN node associated with a time slot preceding the time slot as the source of the of the desynchronization event when the ACP does align with boundaries of the time slot.

Example 12. Further to any previous example, comprising instructions that when executed by processing circuitry, cause the processing circuitry to determine a desynchronization time for the desynchronization event using a probe operation and the first time window or the second time window.

Example 13. Further to any previous example, comprising instructions that when executed by processing circuitry, cause the processing circuitry to: receive a second diagnostic message in the TSN by the security monitor for the diagnostic stream consumer of the TSN, the second diagnostic message to comprise a modified ACP for the diagnostic stream producer, the modified ACP having a length that is less than a length of the ACP; determine the modified ACP fits within a set of boundaries of the first time window; and determine a time difference between one edge of the modified ACP and a boundary of the first time window as a desynchronization time for the desynchronization event.

Example 14. Further to any previous example, comprising instructions that when executed by processing circuitry, cause the processing circuitry to: receive a second diagnostic message in the TSN by the security monitor for the diagnostic stream consumer of the TSN, the second diagnostic message to comprise a modified ACP for the diagnostic stream producer, the modified ACP having a length that is less than a length of the ACP; determine the modified ACP is outside of a set of boundaries of the first time window; and determine a time difference between one edge of the modified ACP and a boundary of a time slot of the second time window as a desynchronization time for the desynchronization event.

Example 15. A computing apparatus comprising: processing circuitry; and a memory storing instructions that, when executed by the processing circuitry, causes the processing circuitry to: receive a diagnostic message in a time-synchronized network (TSN) by a security monitor for a diagnostic stream consumer of the TSN, the diagnostic message to comprise an alignment check packet (ACP) for a diagnostic stream producer; determine whether the ACP aligns with boundaries of a first time window; and generate a security alert to indicate a desynchronization event for the TSN when the ACP is misaligned with the boundaries of the first time window.

Example 16. Further to any previous example, the processing circuitry to: determine the ACP is received in a time slot of a second time window when the ACP is misaligned with the boundaries of the first time window; and identify a TSN node as a source of the desynchronization event based on the time slot of the second time window.

Example 17. Further to any previous example, the processing circuitry to: identify the TSN node associated with the time slot as the source of the desynchronization event when the ACP is misaligned with boundaries of the time slot; or identify the TSN node associated with a time slot preceding the time slot as the source of the of the desynchronization event when the ACP does align with boundaries of the time slot.

Example 18. Further to any previous example, the processing circuitry to determine a desynchronization time for the desynchronization event using a probe operation and the first time window or the second time window.

Example 19. Further to any previous example, the processing circuitry to: receive a second diagnostic message in the TSN by the security monitor for the diagnostic stream consumer of the TSN, the second diagnostic message to comprise a modified ACP for the diagnostic stream producer, the modified ACP having a length that is less than a length of the ACP; determine the modified ACP fits within a set of boundaries of the first time window; and determine a time difference between one edge of the modified ACP and a boundary of the first time window as a desynchronization time for the desynchronization event.

Example 20. Further to any previous example, the processing circuitry to: receive a second diagnostic message in the TSN by the security monitor for the diagnostic stream consumer of the TSN, the second diagnostic message to comprise a modified ACP for the diagnostic stream producer, the modified ACP having a length that is less than a length of the ACP; determine the modified ACP is outside of a set of boundaries of the first time window; and determine a time difference between one edge of the modified ACP and a boundary of a time slot of the second time window as a desynchronization time for the desynchronization event.

It may be appreciated that any of the previous examples may be implemented as systems and/or means plus function embodiments. Embodiments are not limited to these examples.

What is claimed is:

1. A method, comprising:
receiving a diagnostic message in a time-synchronized network (TSN) by a security monitor for a diagnostic stream consumer of the TSN, the diagnostic message to comprise an alignment check packet (ACP) for a diagnostic stream producer;
determining whether the ACP aligns with boundaries of a first time window; and
generating a security alert to indicate a desynchronization event for the TSN when the ACP is misaligned with the boundaries of the first time window.

2. The method of claim 1, comprising:
determining the ACP is received in a time slot of a second time window when the ACP is misaligned with the boundaries of the first time window; and
identifying a TSN node as a source of the desynchronization event based on the time slot of the second time window.

3. The method of claim 2, comprising identifying the TSN node associated with the time slot as the source of the desynchronization event when the ACP is misaligned with boundaries of the time slot.

4. The method of claim 2, comprising identifying the TSN node associated with a time slot preceding the time slot as the source of the of the desynchronization event when the ACP does align with boundaries of the time slot.

5. The method of claim 2, comprising determining a desynchronization time for the desynchronization event using a probe operation and the first time window or the second time window.

6. The method of claim 2, comprising:
receiving a second diagnostic message in the TSN by the security monitor for the diagnostic stream consumer of the TSN, the second diagnostic message to comprise a modified ACP for the diagnostic stream producer, the modified ACP having a length that is less than a length of the ACP;
determining the modified ACP fits within a set of boundaries of the first time window; and
determining a time difference between one edge of the modified ACP and a boundary of the first time window as a desynchronization time for the desynchronization event.

7. The method of claim 2, comprising:
receiving a second diagnostic message in the TSN by the security monitor for the diagnostic stream consumer of the TSN, the second diagnostic message to comprise a modified ACP for the diagnostic stream producer, the modified ACP having a length that is less than a length of the ACP;
determining the modified ACP is outside of a set of boundaries of the first time window; and
determining a time difference between one edge of the modified ACP and a boundary of a time slot of the second time window as a desynchronization time for the desynchronization event.

8. A non-transitory computer-readable storage medium, the computer-readable storage medium including instructions that when executed by processing circuitry, cause the processing circuitry to:
receive a diagnostic message in a time-synchronized network (TSN) by a security monitor for a diagnostic stream consumer of the TSN, the diagnostic message to comprise an alignment check packet (ACP) for a diagnostic stream producer;
determine whether the ACP aligns with boundaries of a first time window; and
generate a security alert to indicate a desynchronization event for the TSN when the ACP is misaligned with the boundaries of the first time window.

9. The computer-readable storage medium of claim 8, comprising instructions that when executed by processing circuitry, cause the processing circuitry to:
determine the ACP is received in a time slot of a second time window when the ACP is misaligned with the boundaries of the first time window; and
identify a TSN node as a source of the desynchronization event based on the time slot of the second time window.

10. The computer-readable storage medium of claim 9, comprising instructions that when executed by processing circuitry, cause the processing circuitry to identify the TSN node associated with the time slot as the source of the desynchronization event when the ACP is misaligned with boundaries of the time slot.

11. The computer-readable storage medium of claim 9, comprising instructions that when executed by processing circuitry, cause the processing circuitry to identify the TSN node associated with a time slot preceding the time slot as the source of the of the desynchronization event when the ACP does align with boundaries of the time slot.

12. The computer-readable storage medium of claim 9, comprising instructions that when executed by processing circuitry, cause the processing circuitry to determine a desynchronization time for the desynchronization event using a probe operation and the first time window or the second time window.

13. The computer-readable storage medium of claim 9, comprising instructions that when executed by processing circuitry, cause the processing circuitry to:
receive a second diagnostic message in the TSN by the security monitor for the diagnostic stream consumer of the TSN, the second diagnostic message to comprise a modified ACP for the diagnostic stream producer, the modified ACP having a length that is less than a length of the ACP;
determine the modified ACP fits within a set of boundaries of the first time window; and
determine a time difference between one edge of the modified ACP and a boundary of the first time window as a desynchronization time for the desynchronization event.

14. The computer-readable storage medium of claim 9, comprising instructions that when executed by processing circuitry, cause the processing circuitry to:
receive a second diagnostic message in the TSN by the security monitor for the diagnostic stream consumer of the TSN, the second diagnostic message to comprise a modified ACP for the diagnostic stream producer, the modified ACP having a length that is less than a length of the ACP;
determine the modified ACP is outside of a set of boundaries of the first time window; and
determine a time difference between one edge of the modified ACP and a boundary of a time slot of the second time window as a desynchronization time for the desynchronization event.

15. A computing apparatus comprising:
processing circuitry; and
a memory storing instructions that, when executed by the processing circuitry, causes the processing circuitry to:
receive a diagnostic message in a time-synchronized network (TSN) by a security monitor for a diagnostic stream consumer of the TSN, the diagnostic message to comprise an alignment check packet (ACP) for a diagnostic stream producer;
determine whether the ACP aligns with boundaries of a first time window; and
generate a security alert to indicate a desynchronization event for the TSN when the ACP is misaligned with the boundaries of the first time window.

16. The computing apparatus of claim 15, the processing circuitry to:
determine the ACP is received in a time slot of a second time window when the ACP is misaligned with the boundaries of the first time window; and
identify a TSN node as a source of the desynchronization event based on the time slot of the second time window.

17. The computing apparatus of claim 16, the processing circuitry to:
identify the TSN node associated with the time slot as the source of the desynchronization event when the ACP is misaligned with boundaries of the time slot; or
identify the TSN node associated with a time slot preceding the time slot as the source of the of the desynchronization event when the ACP does align with boundaries of the time slot.

18. The computing apparatus of claim 16, the processing circuitry to determine a desynchronization time for the desynchronization event using a probe operation and the first time window or the second time window.

19. The computing apparatus of claim 16, the processing circuitry to:
receive a second diagnostic message in the TSN by the security monitor for the diagnostic stream consumer of the TSN, the second diagnostic message to comprise a modified ACP for the diagnostic stream producer, the modified ACP having a length that is less than a length of the ACP;
determine the modified ACP fits within a set of boundaries of the first time window; and
determine a time difference between one edge of the modified ACP and a boundary of the first time window as a desynchronization time for the desynchronization event.

20. The computing apparatus of claim 16, the processing circuitry to:
receive a second diagnostic message in the TSN by the security monitor for the diagnostic stream consumer of the TSN, the second diagnostic message to comprise a modified ACP for the diagnostic stream producer, the modified ACP having a length that is less than a length of the ACP;
determine the modified ACP is outside of a set of boundaries of the first time window; and
determine a time difference between one edge of the modified ACP and a boundary of a time slot of the second time window as a desynchronization time for the desynchronization event.
